(19) United States
(12) Patent Application Publication
(10) Pub. No.: US 2009/0029252 A1
(43) Pub. Date: Jan. 29, 2009

(54) ANODE, BATTERY, AND METHODS OF MANUFACTURING THEM

(75) Inventors: Hideki Nakai, Fukushima (JP); Masayuki Ihara, Fukushima (JP); Hiroyuki Yamaguchi, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/144,766

(22) Filed: Jun. 24, 2008

(30) Foreign Application Priority Data
Jul. 23, 2007 (JP) 2007-190977

(51) Int. Cl. H01M 4/48; H01M 4/40; H01M 4/04

(52) U.S. Cl. 429/218.1; 429/231.95; 29/623.1; 423/512.1

(57) ABSTRACT

A battery capable of improving the cycle characteristics is provided. The battery includes a cathode, an anode and an electrolytic solution. The anode has a coat on an anode active material layer provided on an anode current collector. The anode active material layer contains an anode material that is capable of inserting and extracting an electrode reactant and has at least one of a metal element and a metalloid element. The coat contains a metal salt having sulfur and oxygen.

### CROSS REFERENCES TO RELATED APPLICATIONS

The present invention contains subject matter related to Japanese Patent Application JP 2007-190977 filed in the Japanese Patent Office on Jul. 23, 2008, the entire contents of which being incorporated herein by reference.

### BACKGROUND OF THE INVENTION

1. Field of the Invention

The present invention relates to an anode having an anode active material layer on an anode current collector, a battery using it, and methods of manufacturing them.

2. Description of the Related Art

In recent years, portable electronic devices such as combination cameras (videotape recorder), digital still cameras, mobile phones, Personal Digital Assistants, and notebook personal computers have been widely used, and it is strongly demanded to reduce their size and weight and to achieve their long life. Accordingly, as a power source for the portable electronic devices, a battery, in particular a light-weight secondary batter capable of providing a high energy density has been developed.

Specially, a secondary battery using insertion and extraction of lithium for charge and discharge reaction (so-called lithium ion secondary battery) is extremely prospective, since such a secondary battery provides a higher energy density than that of a lead battery and a nickel cadmium battery. The lithium ion secondary battery includes a cathode, an anode, and an electrolytic solution. As an active material of the anode (anode active material), a carbon material has been widely used.

In recent years, as high performance of the portable electronic devices is developed, further improvement of the battery capacity is demanded. Thus, it has been considered to use silicon, tin or the like instead of the carbon material as an anode active material (for example, refer to U.S. Pat. No. 4,950,566). Since the theoretical capacity of silicon (4199 mAh/g) and the theoretical capacity of tin (994 mAh/g) are significantly higher than the theoretical capacity of graphite (372 mAh/g), it is prospected that the battery capacity is thereby highly improved.

However, in the lithium ion secondary battery using silicon or the like as an anode active material, there has been the following issue. The anode active material inserting lithium in charge becomes highly activated, and thus the electrolytic solution is easily decomposed and lithium is easily inactivated. In the result, when charge and discharge are repeated, the discharge capacity is easily lowered and thus it is hard to obtain sufficient cycle characteristics.

To improve the battery characteristics typified by the cycle characteristics, various techniques have been already proposed. Specifically, a technique to form a coat such as lithium carbonate and lithium fluoride as an inert layer on the surface of the anode has been known (for example, refer to Japanese Unexamined Patent Application Publication No 2005-166469). Further, a technique to add a chain disulfonic acid anhydride, a cyclic sulfonic acid/carboxylic acid anhydride or the like as an additive to an electrolytic solution has been known (for example, refer to Japanese Unexamined Patent Application Publication Nos. 10-189041, 2002-008718, 2002-313418, and 2005-502179).

### SUMMARY OF THE INVENTION

The high performance and the multi functions of the recent portable electronic devices are increasingly developed. Accordingly, there is a tendency that charge and discharge of the secondary battery are frequently repeated, and thus decomposition reaction of the electrolytic solution tends to easily proceed. Accordingly, further improvement of the cycle characteristics of the secondary battery has been aspired.

In view of the foregoing, in the invention, it is desirable to provide an anode and a battery capable of improving the cycle characteristics and methods of manufacturing them.

According to an embodiment of the invention, there is provided an anode including a coat on an anode active material layer provided on an anode current collector. The anode active material layer contains an anode material that is capable of inserting and extracting an electrode reactant and has at least one of a metal element and a metalloid element. The coat contains a metal salt having sulfur and oxygen. According to an embodiment of the invention, there is provided a method of manufacturing an anode, in which after an anode active material layer containing an anode material that is capable of inserting and extracting an electrode reactant and has at least one of a metal element and a metalloid element is formed on an anode current collector, a coat is formed on the anode active material layer by using a solution containing a metal salt having sulfur and oxygen.

According to an embodiment of the invention, there is provided a battery including a cathode, an anode, and an electrolytic solution. The anode has a coat on an anode active material layer provided on an anode current collector. The anode active material layer contains an anode material that is capable of inserting and extracting an electrode reactant and has at least one of a metal element and a metalloid element. The coat contains a metal salt having sulfur and oxygen. According to an embodiment of the invention, there is provided a method of manufacturing a battery including a cathode, an anode, and an electrolytic solution in which the anode has a coat on an anode active material layer provided on an anode current collector. In the method, after the anode active material layer containing an anode material that is capable of inserting and extracting an electrode reactant and has at least one of a metal element and a metalloid element is formed on the anode current collector, the coat is formed on the anode active material layer by using a solution containing a metal salt having sulfur and oxygen.

According to another embodiment of the invention, there is provided a battery including a cathode, an anode, and an electrolytic solution. The anode has an anode active material layer provided on an anode current collector. The anode active material layer contains an anode material that is capable of inserting and extracting an electrode reactant and has at least one of a metal element and a metalloid element. The electrolytic solution contains a compound having a sulfonyl group. At least one peak of ions selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion is obtained by surface analysis of the anode using Time of Flight Secondary Ion Mass Spectrometry after charge and discharge.

According to the anode and the method of manufacturing it, or the battery and the method of manufacturing it of the embodiments of the invention, the anode active material layer of the anode contains the anode material that is capable of inserting and extracting electrode reactant and has at least one of a metal element and a metalloid element. In this case, in the case where the coat containing the metal salt having sulfur and oxygen is formed on the anode active material layer before charge and discharge, the chemical stability of the anode is improved, and thus decomposition reaction of the electrolytic solution is inhibited. Otherwise, in the case where the compound having a sulfonyl group is contained in the electrolytic solution, once charge and discharge are performed, the coat containing the metal salt having sulfur and oxygen is formed on the anode active material layer. In this case, at least one peak of ions selected from the group consisting of positive secondary ions (Li₃SO₄+, Li₃SO₃+, Li₂SO₃+, and Li₂SO₂+) and negative secondary ions (LiSO₄−, LiSO₃−, SO₃−, and SO₂−) is obtained by surface analysis of the anode using Time of Flight Secondary Ion Mass Spectrometry after charge and discharge, and thus decomposition reaction of the electrolytic solution is inhibited. Therefore, the cycle characteristics may be improved. In this case, since the coat is formed by using the solution containing a metal salt having sulfur and oxygen, a favorable coat may be easily formed compared to a case using a method necessitating particular environmental conditions such as reduced pressure environment.

Other and further objects, features and advantages of the invention will appear more fully from the following description.

### BRIEF DESCRIPTION OF THE DRAWINGS

FIG. 1 is a cross section showing a structure of a battery according to a first embodiment of the invention;

FIG. 2 is a cross section showing an enlarged part of the spirally wound electrode body shown in FIG. 1;

FIG. 3 is a plan view showing a structure of the cathode and the anode shown in FIG. 2;

FIG. 4 is an exploded perspective view showing a structure of a battery according to a second embodiment of the invention;

FIG. 5 is a cross section showing a structure taken along line V-V of the spirally wound electrode body shown in FIG. 4;

FIG. 6 is a cross section showing an enlarged part of the spirally wound electrode body shown in FIG. 5;

FIG. 7 is a cross section showing a structure of a battery according to a third embodiment of the invention;

FIG. 8 is a cross section showing a structure of a main part of a battery according to a fourth embodiment of the invention;

FIG. 9 is a plan view showing a structure of the cathode and the anode shown in FIG. 8;

FIG. 10 is a cross section showing a structure of a main part of a battery according to a fifth embodiment of the invention;

FIG. 11 is a cross section showing a structure of a battery according to a sixth embodiment of the invention;

FIG. 12 is a diagram showing the surface analysis result (positive secondary ion) of the secondary battery of Example 1-7 with the use of TOF-SIMS;

FIG. 13 is a diagram showing the surface analysis result (negative secondary ion) of the secondary battery of Example 1-7 with the use of TOF-SIMS; and

FIG. 14 is a diagram showing the analytical result of an SnCoC-containing material with the use of XPS.

### DETAILED DESCRIPTION OF THE PREFERRED EMBODIMENTS

Embodiments of the invention will be hereinafter described in detail with reference to the drawings.

### First Embodiment

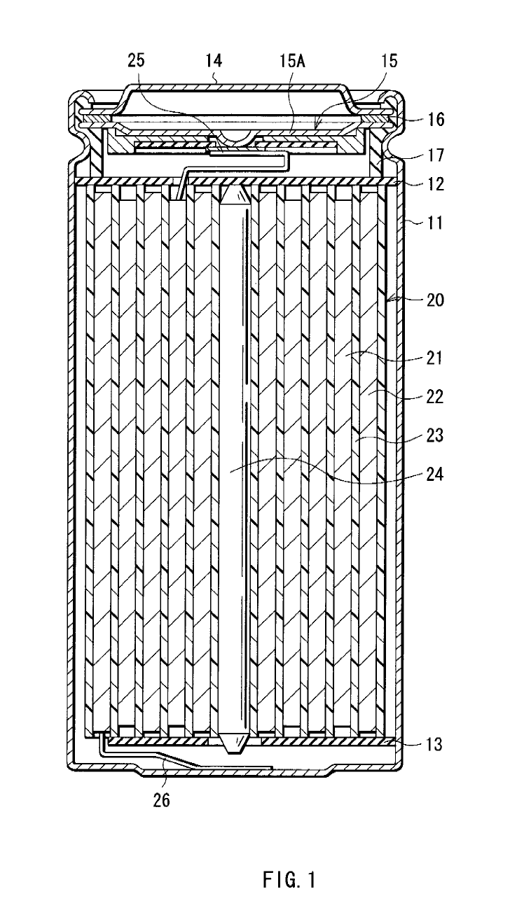

FIG. 1 shows a cross sectional structure of a battery according to a first embodiment of the invention. The battery is, for example, a lithium ion secondary battery in which the anode capacity is expressed based on insertion and extraction of lithium as an electrode reactant. The anode of the invention is applied to the secondary battery described below.

In the secondary battery, a spirally wound electrode body 20 in which a cathode 21 and an anode 22 are layered with a separator 23 in between and spirally wound, and a pair of insulating plates 12 and 13 are contained in a battery can 11 in the shape of an approximately hollow cylinder. The battery can 11 is made of, for example, iron plated by nickel. One end of the battery can 11 is closed, and the other end thereof is opened. The pair of insulating plates 12 and 13 is respectively arranged perpendicular to the winding periphery face, so that the spirally wound electrode body 20 is sandwiched between the insulating plates 12 and 13. The battery structure using the cylindrical battery can 11 is called cylindrical type.

At the open end of the battery can 11, a battery cover 14, and a safety valve mechanism 15 and a Positive Temperature Coefficient (PTC) device 16 provided inside the battery cover 14 are attached by being caulked with a gasket 17. Inside of the battery can 11 is thereby hermetically closed. The battery cover 14 is, for example, made of a material similar to that of the battery can 11. The safety valve mechanism 15 is electrically connected to the battery cover 14 through the PTC device 16. If the internal pressure of the battery becomes a certain level or more due to internal short circuit, external heating or the like, a disk plate 15A flips to cut the electric connection between the battery cover 14 and the spirally wound electrode body 20. The PTC device 16 limits a current by increasing the resistance associated with increased temperature to prevent abnormal heat generation resulting from a large current. The gasket 17 is made of, for example, an insulating material and its surface is coated with asphalt.

A center pin 24 may be inserted in the center of the spirally wound electrode body 20. In the spirally wound electrode body 20, a cathode lead 25 made of aluminum or the like is connected to the cathode 21, and an anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

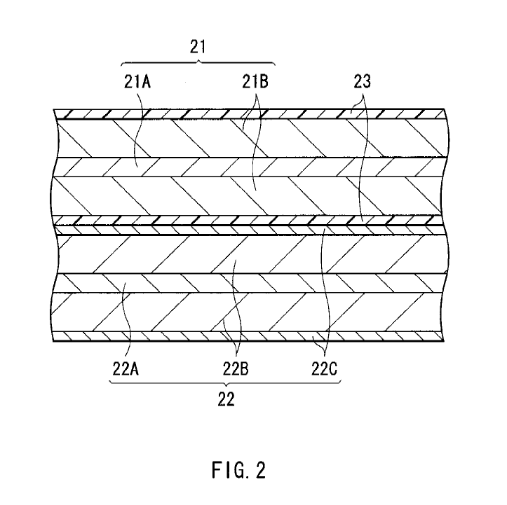

FIG. 2 shows an enlarged part of the spirally wound electrode body 20 shown in FIG. 1.

The cathode 21 has, for example, a cathode current collector 21A having a pair of opposed faces and a cathode active material layer 21B provided on the both faces of the cathode current collector 21A. The cathode active material layer 21B may be provided on only a single face of the cathode current collector 21A.

The cathode current collector 21A is made of, for example, a metal material such as aluminum, nickel, and stainless. The cathode active material layer 21B contains as a cathode active material, one or more cathode materials capable of inserting and extracting lithium as an electrode reactant. The cathode active material layer 21B may contain an electrical conductor, a binder or the like according to needs.

The cathode material is, for example, a lithium-containing compound such as a lithium oxide, a lithium sulfide, an intercalation compound containing lithium, and a lithium phosphate compound. Specially, a complex oxide containing lithium and a transition metal element or a phosphate compound containing lithium and a transition metal element is preferable. In particular, a compound containing at least one selected from the group consisting of cobalt, nickel, manganese, iron, aluminum, vanadium, and titanium as a transition metal element is preferable, since thereby a high energy density is obtained. The chemical formula thereof is expressed by, for example, LiₓM1O₂ or Li_{y}M2PO₄. In the formula, M1 and M2 represent one or more transition metal elements. Values of x and y vary according to charge and discharge states of the battery, and are generally in the range of 0.05≦x≦1.10 and 0.05≦y≦1.10.

As the complex oxide containing lithium and a transition metal element, for example, a lithium-cobalt complex oxide (LiₓCoO₂), a lithium-nickel complex oxide (LiₓNiO₂), a lithium-nickel-cobalt complex oxide (LiₓNi_{(1-z)}Co_{z}O₂ (z<1)), a lithium-nickel-cobalt-manganese complex oxide (LiₓNi_{1(1-v-w)}CoᵥMn_{w}O₂ (v+w<1)), lithium-manganese complex oxide having a spinel type structure (LiMn₂O₄) and the like are cited. Specially, the complex oxide containing nickel is preferable, since thereby a high capacity and superior cycle characteristics are obtained. As the phosphate compound containing lithium and a transition metal element, for example, lithium-iron phosphate compound (LiFePO₄), a lithium-iron-manganese phosphate compound (LiFe₍₁₋ᵤ₎MnᵤPO₄ (u<1)) or the like is cited.

In addition to the foregoing compounds, for example, the cathode active material layer 21B may contain other metal compound, a polymer compound or the like as a cathode active material. As other metal compound, for example, an oxide such as titanium oxide, vanadium oxide, and manganese dioxide; a disulfide such as iron disulfide, titanium disulfide, and molybdenum disulfide; and a chalcogenide such as niobium selenide are cited. As the polymer compound, for example, polyaniline, polythiophene or the like is cited.

As the electrical conductor, for example, a carbon material such as graphite, carbon black, acetylene black, and Ketjen black is cited. Such a carbon material may be used singly, or a plurality thereof may be used by mixture. The electrical conductor may be a metal material, a conductive polymer or the like as long as the material has the electric conductivity.

As the binder, for example, a synthetic rubber such as styrene-butadiene rubber, fluorinated rubber, and ethylene propylene diene; or a polymer material such as polyvinylidene fluoride is cited. One thereof may be used singly, or a plurality thereof may be used by mixture.

The anode 22 has an anode current collector 22A having a pair of opposed faces, an anode active material layer 22B provided on the both faces of the anode current collector 22A, and a coat 22C provided on the anode active material layer 22B. The anode active material layer 22B may be provided on only a single face of the anode current collector 22A. The coat 22C may be also provided on only a single face of the anode active material layer 22B.

The anode current collector 22A is preferably made of a metal material having favorable electrochemical stability, electric conductivity, and mechanical strength. As the metal material, for example, copper, nickel, stainless and the like are cited. Specially, copper is preferable, since thereby high electric conductivity is obtained.

The anode active material layer 22B contains as an anode active material, one or more anode materials that is capable of inserting and extracting lithium as an electrode reactant and has at least one of a metal element and a metalloid element as an element, since thereby a high energy density is obtained. The anode active material layer 22B may contain an electrical conductor, a binder or the like according to needs.

The anode material may be a simple substance, an alloy, or a compound of a metal element or a metalloid element, or may be a material having one or more phases thereof at least in part. “Alloy” in the invention includes an alloy containing one or more metal elements and one or more metalloid elements, in addition to an alloy composed of two or more metal elements. Further, “alloy” in the invention may contain a nonmetallic element. The texture thereof includes a solid solution, a eutectic crystal (eutectic mixture), an intermetallic compound, and a texture in which two or more thereof coexist.

As the foregoing metal element or the foregoing metalloid element, for example, a metal element or a metalloid element capable of forming an alloy with lithium is cited. Specifically, magnesium, boron, aluminum, gallium, indium, silicon, germanium (Ge), tin, lead (Pb), bismuth, cadmium (Cd), silver, zinc, hafnium, zirconium, yttrium (Y), palladium (Pd), platinum (Pt) and the like are cited. Specially, at least one selected from the group consisting of silicon and tin is preferable. Silicon and tin have the high ability to insert and extract lithium, and thus provide a high energy density.

As an anode material containing at least one of silicon and tin, for example, the simple substance, an alloy, or a compound of silicon; the simple substance, an alloy, or a compound of tin; or a material having one or more phases thereof at least in part is cited. Each thereof may be used singly, or a plurality thereof may be used by mixture.

As the anode material having the simple substance of silicon, for example, a material containing the simple substance of silicon as a main body is cited. The anode active material layer 22B containing such a kind of anode material has, for example, a structure in which oxygen and the second element other than silicon exist between silicon simple substance layers. The total content of silicon and oxygen in the anode active material layer 22B is preferably 50 wt % or more, and in particular, the content of the silicon simple substance is preferably 50 wt % or more. As the second element other than silicon, for example, titanium, chromium, manganese, iron, cobalt, nickel, copper, zinc, indium, silver, magnesium, aluminum, germanium, tin, bismuth, antimony (Sb) and the like are cited. The anode active material layer 22B that contains the material containing the simple substance of silicon as a main body is formed by co-evaporating silicon and other element.

As the alloy of silicon, for example, a material containing at least one selected from the group consisting of tin, nickel, copper, iron, cobalt, manganese, zinc, indium, silver, titanium, germanium, bismuth, antimony, and chromium as the second element other than silicon is cited. As the compound of silicon, for example, a material containing oxygen or carbon is cited, and may contain the foregoing second element in addition to silicon. Examples of an alloy or a compound of silicon include, for example, SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), SnO_{w} (0<w≦2), LiSiO or the like is cited.

As the alloy of tin, for example, a material containing at least one selected from the group consisting of silicon, nickel, copper, iron, cobalt, manganese, zinc, indium, silver, titanium, germanium, bismuth, antimony, and chromium as the second element other than tin is cited. As the compound of tin, for example, a compound containing oxygen or carbon is cited. The compound may contain the foregoing second element in addition to tin. Examples of the alloy or the compound of tin include SnSiO₃, LiSnO, Mg₂Sn or the like.

In particular, as the anode material containing at least one of silicon and tin, for example, a material containing the second element and the third element in addition to tin as the first element is preferable. The second element is at least one selected from the group consisting of cobalt, iron, magnesium, titanium, vanadium, chromium, manganese, nickel, copper, zinc, gallium, zirconium, niobium, molybdenum, silver, indium, cerium, hafnium, tantalum, tungsten, bismuth, and silicon. The third element is at least one selected from the group consisting of boron, carbon, aluminum, and phosphorus. When the second element and the third element are contained, a high energy density is obtained.

Specially, a SnCoC-containing material that has tin, cobalt, and carbon in which the carbon content is in the range from 9.9 wt % to 29.7 wt % and the cobalt ratio to the total of tin and cobalt (Co/(Sn+Co)) is in the range from 30 wt % to 70 wt % is preferable. In such a composition range, a high energy density is obtained.

The SnCoC-containing material may further contain other element according to needs. As other element, for example, silicon, iron, nickel, chromium, indium, niobium, germanium, titanium, molybdenum, aluminum, phosphorus, gallium, bismuth or the like is preferable. Two or more thereof may be contained, since thereby the energy density is further improved.

The SnCoC-containing material has a phase containing tin, cobalt, and carbon. Such a phase preferably has a low crystalline structure or an amorphous structure. Further, in the SnCoC-containing material, at least part of carbon as an element is preferably bonded to a metal element or a metalloid element as other element. Cohesion or crystallization of tin or the like is thereby inhibited.

The SnCoC-containing material may be formed by, for example, mixing raw materials of each element, dissolving the resultant mixture in an electric furnace, a high frequency induction furnace, an arc melting furnace or the like and then solidifying the resultant. Otherwise, the SnCoC-containing material may be formed by various atomization methods such as gas atomizing and water atomizing; various roll methods; or a method using mechanochemical reaction such as mechanical alloying method and mechanical milling method. Specially, the SnCoC-containing material is preferably formed by the method using mechanochemical reaction, since thereby the anode active material has a low crystalline structure or an amorphous structure. For the method using the mechanochemical reaction, for example, an apparatus such as a planetary ball mill apparatus and an attliter may be used.

As a measurement method for examining bonding state of elements, for example, X-ray Photoelectron Spectroscopy (XPS) is cited. In XPS, in the case of graphite, the peak of 1s orbit of carbon (C1s) is observed at 284.5 eV in the apparatus in which energy calibration is made so that the peak of 4f orbit of gold atom (Au4f) is obtained at 84.0 eV. In the case of surface contamination carbon, the peak is observed at 284.8 eV. Meanwhile, in the case of higher electric charge density of carbon element, for example, when carbon is bonded to a metal element or a metalloid element, the peak of C1s is observed in the region lower than 284.5 eV. That is, when the peak of the composite wave of C1s obtained for the SnCoC-containing material is observed in the region lower than 284.5 eV, at least part of carbon contained in the SnCoC-containing material is bonded to the metal element or the metalloid element as other element.

In XPS, for example, the peak of C1s is used for correcting the energy axis of spectrums. Since surface contamination carbon generally exists on the surface, the peak of C1s of the surface contamination carbon is set to in 284.8 eV, which is used as an energy reference. In XPS, the waveform of the peak of C1s is obtained as a form including the peak of the surface contamination carbon and the peak of carbon in the SnCoC-containing material. Therefore, for example, by performing analysis by using commercially available software, the peak of the surface contamination carbon and the peak of carbon in the SnCoC-containing material are separated. In the analysis of the waveform, the position of the main peak existing on the lowest bound energy side is set to the energy reference (284.8 eV).

The anode active material layer 22B using the anode material containing the simple substance, an alloy, or a compound of silicon; the simple substance, an alloy, or a compound of tin; or the material having one or more phases thereof at least in part may be formed by, for example, vapor-phase deposition method, liquid-phase deposition method, spraying method, firing method, or a combination of two or more of these methods. In this case, the anode current collector 22A and the anode active material layer 22B are preferably alloyed in at least part of the interface thereof. Specifically, at the interface thereof, the element of the anode current collector 22A may be diffused in the anode active material layer 22B; or the element of the anode active material layer 22B may be diffused in the anode current collector 22A; or these elements may be diffused in each other. Thereby, destruction due to expansion and shrinkage of the anode active material layer 22B associated with charge and discharge is inhibited, and the electron conductivity between the anode current collector 22A and the anode active material layer 22B is improved.

As vapor-phase deposition method, for example, physical deposition method or chemical deposition method is cited. Specifically, vacuum evaporation method, sputtering method, ion plating method, laser ablation method, thermal Chemical Vapor Deposition (CVD) method, plasma CVD method and the like are cited. As liquid-phase deposition method, a known technique such as electrolytic plating and electroless plating may be used. Firing method is, for example, a method in which a particulate anode active material mixed with a binder or the like is dispersed in a solvent and the anode current collector is coated with the resultant, and then heat treatment is provided at a temperature higher than the melting point of the binder or the like. For firing method, a known technique such as atmosphere firing method, reactive firing method, and hot press firing method is available as well.

In addition to the foregoing, as the material capable of inserting and extracting lithium, for example, the anode active material layer 22B may contain a carbon material. As the carbon material, for example, graphitizable carbon, non-graphitizable carbon in which the spacing of (002) plane is 0.37 nm or more, graphite in which the spacing of (002) plane is 0.34 nm or less and the like are cited. More specifically, pyrolytic carbons, coke, glassy carbon fiber, an organic polymer compound fired body, activated carbon, carbon black or the like is cited. Of the foregoing, the coke includes pitch coke, needle coke, petroleum coke and the like. The organic polymer compound fired body is obtained by firing and carbonizing a phenol resin, a furan resin or the like at an appropriate temperature. In the carbon material, a change in the crystal structure associated with insertion and extraction of lithium is very small. Therefore, by using the carbon material, a high energy density is obtained and superior cycle characteristics are obtained. In addition, the carbon material also functions as an electrical conductor, and thus the carbon material is preferably used. The shape of the carbon material may be any of a fibrous shape, a spherical shape, a granular shape, and a scale-like shape.

Further, as the material capable of inserting and extracting lithium, for example, the anode active material layer 22B may contain a metal oxide, a polymer compound and the like. As the metal oxide, for example, iron oxide, ruthenium oxide, molybdenum oxide or the like is cited. As the polymer compound, for example, polyacetylene, polyaniline, polypyrrole or the like is cited.

As the anode active material, an anode material may be used singly, or the anode material and the foregoing carbon material may be used by mixture, as long as the anode material having at least one of the metal element and the metalloid element is included.

In the secondary battery, it is preferable that the charge capacity of the anode active material is larger than the charge capacity of the cathode active material by adjusting the amount of the cathode active material and the amount of the anode active material capable of inserting and extracting lithium.

The types of electrical conductor and the binder are similar to those described in the cathode 21. When the cathode 21 and the anode 22 are spirally wound, styrene-butadiene rubber, fluorinated rubber or the like having flexibility is preferable.

The coat 22C may cover the entire surface of the anode active material layer 22B or may cover part thereof. However, the coat 22C preferably covers a greater part thereof. At this time, part of the coat 22C may intrude into the anode active material layer 22B. When the coat 22C is provided on the anode active material layer 22B, the chemical stability of the anode 22 is improved, and thereby decomposition reaction of the electrolytic solution in charge and discharge is inhibited.

The coat 22C may contain one or more metal salts having sulfur and oxygen as an element.

Classifying by types of anion, as the metal salt, for example, a hydrosulfate, a subsulfate, or a thiosulfate; a salt obtained by substituting at least part of hydrogen thereof with halogen (for example, fluorosulfate) and the like are cited. Specially, at least one of hydrosulfate, subsulfate, and thiosulfate is preferable, and subsulfate is more preferable, since thereby the chemical stability of the anode 22 is further improved.

Classifying by types of cation, the type of metal salt is not particularly limited, but a salt of a metal of the same type as lithium as the electrode reactant (lithium salt) is preferable. In this case, the chemical stability of the anode 22 is further improved compared to a case that the metal salt is a salt of a metal other than lithium.

Specific examples of the metal salt include, lithium sulfate (Li₂SO₄), lithium subsulfate (Li₂SO₃), or lithium thiosulfate (Li₂S₂O₃) and the like. These metal salts may be used singly, or a plurality thereof may be used by mixture.

In particular, since the coat 22C is provided on the anode active material layer 22B, it is preferable that a specific secondary ion peak originated from existence of the coat 22C is obtained by surface analysis of the anode 22 using Time of Flight Secondary Ion Mass Spectrometry (TOF-SIMS). The specific secondary ion is at least one selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion.

In this case, as the detection amount of positive secondary ion (counting of ions) detected when radiating Bi₃+ (9.7952×10¹¹ ions/cm²) as a primary ion, the counting of the detection amount of Li₃SO₄+ is preferably 10000 or more, and the counting of the detection amount of Li₃SO₃+ is preferably 9000 or more. Thereby, the chemical stability of the anode 22 is improved.

As a method of forming the coat 22C, for example, liquid-phase deposition method such as coating method and dipping method (so-called dip coating method); vapor-phase deposition method such as evaporation method, sputtering method, and Chemical Vapor Deposition (CVD) method or the like is cited. One of these methods may be used singly, or a plurality thereof may be used together. Specially, liquid-phase deposition method using a solution containing a metal salt having sulfur and oxygen is preferable, since thereby the favorable coat 22C having superior chemical stability may be easily formed. A solvent in which the foregoing metal salt is dissolved is not particularly limited, but water is preferable. Water has a high polarity. Thus, water easily dissolve the metal salt. In addition, since the aqueous coat 22C is formed in this case, the coat 22C is hardly dissolved when used in combination with a nonaqueous solvent-based electrolytic solution.

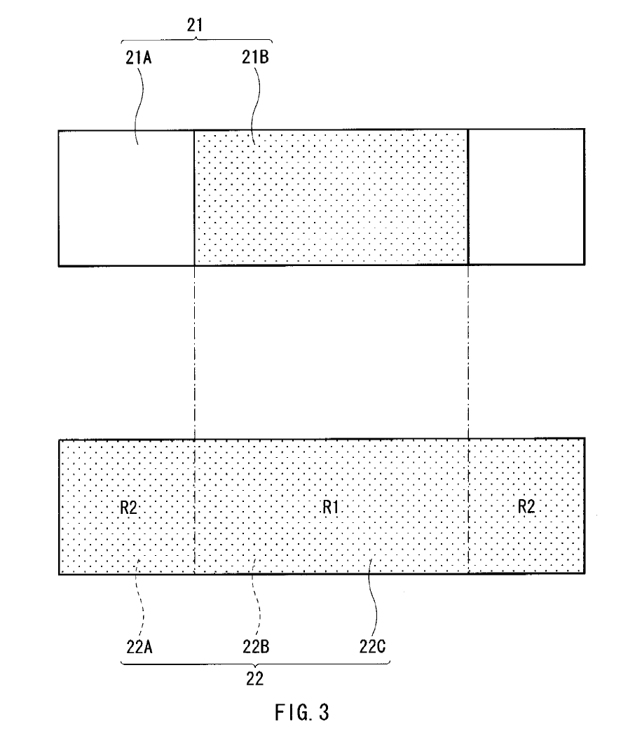

FIG. 3 shows a planar structure of the cathode 21 and the anode 22 shown in FIG. 2. In FIG. 3, the range of forming the cathode active material layer 21B of the cathode 21 is provided with half-tone dot meshing, and the range of forming the anode active material layer 22B and the coat 22C of the anode 22 is provided with half-tone dot meshing.

In the secondary battery, for example, the cathode active material layer 21B is partially provided on the cathode current collector 21A, while the anode active material layer 22B is provided on the whole area of the anode current collector 22A. In this case, the coat 22C is, for example, provided on the whole area of the anode active material layer 22B, that is, the coat 22C is provided in both region R1 opposed to the cathode active material layer 21B and region R2 not opposed to the cathode active material layer 21B.

The separator 23 separates the cathode 21 from the anode 22, prevents current short circuit due to contact of both electrodes, and passes lithium ions. The separator 23 is made of, for example, a porous film made of a synthetic resin such as polytetrafluoroethylene, polypropylene, and polyethylene, or a ceramic porous film. The separator 23 may have a structure in which two or more of the foregoing porous films are layered. Specially, the porous film made of polyolefin is preferable, since such a film has a superior short circuit preventive effect and may improve battery safety by shutdown effect. In particular, polyethylene is preferable, since polyethylene provides shutdown effect at from 100 deg C. to 160 deg C. and has superior electrochemical stability. Further, polypropylene is also preferable. In addition, as long as chemical stability is secured, a resin formed by copolymerizing or blending with polyethylene or polypropylene may be used.

An electrolytic solution as a liquid electrolyte is impregnated in the separator 23. The electrolytic solution contains a solvent and an electrolyte salt dissolved in the solvent.

The solvent contains, for example, one or more nonaqueous solvents such as an organic solvent. As the nonaqueous solvents, for example, ethylene carbonate, propylene carbonate, butylene carbonate, dimethyl carbonate, diethyl carbonate, ethyl methyl carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, ethyl propionate, acetonitrile, glutaronitrile, adiponitrile, methoxyacetonitrile, 3-methoxypropionitrile, N,N-dimethylformamide, N-methylpyrrolidinone, N-methyloxazolidinone, nitromethane, nitroethane, sulfolane, dimethyl sulfoxide, trimethyl phosphate, ethylene sulfite, bistrifluoromethylsulfonylimide trimethylhexylammonium and the like are cited. Specially, at least one of ethylene carbonate, propylene carbonate, dimethyl carbonate, diethyl carbonate, and ethyl methyl carbonate is preferable. Thereby, a superior capacity, superior cycle characteristics, and superior storage characteristics are obtained. In this case, in particular, a mixture of a high-viscosity (high dielectric constant) solvent (for example, specific inductive ε>30) such as ethylene carbonate and propylene carbonate and a low-viscosity solvent (for example, viscosity≦1 mPa.s) such as dimethyl carbonate, ethyl methyl carbonate, and diethyl carbonate is preferable. Thereby, the dissociation property of the electrolyte salt and the ion mobility are improved, and thus higher effects are obtained.

The solvent preferably contains a cyclic ester carbonate having an unsaturated bond, a chain ester carbonate having a halogen as an element, a cyclic ester carbonate having a halogen as an element or the like, since thereby the cycle characteristics are improved. As the cyclic ester carbonate having an unsaturated bond, for example, vinylene carbonate, vinylethylene carbonate and the like are cited. As the chain ester carbonate having a halogen, for example, fluoromethyl methyl carbonate, bis(fluoromethyl) carbonate, difluoromethyl methyl carbonate and the like are cited. As the cyclic ester carbonate having a halogen, for example, 4-fluoro-1,3-dioxolane-2-one, 4,5-difluoro-1,3-dioxolane-2-one and the like are cited. One thereof may be used singly, or a plurality thereof may be used by mixture.

The electrolyte salt contains, for example, one or more light metal salts such as a lithium salt. As the lithium salt, for example, lithium hexafluorophosphate (LiPF₆), lithium tetrafluoroborate (LiBF₄), lithium perchlorate (LiClO₄), lithium hexafluoroarsenate (LiAsF₆), lithium bis(pentafluoroethanesulfonyl)imide (LiN(C₂F₅SO₂)₂), lithium trifluoromethanesulfonate (LiCF₃SO₃), lithium bis(trifluoromethanesulfonyl)imide (LiN(CF₃SO₂)₂), lithium tris(trifluoromethanesulfonyl)methide (LiC(CF₃SO₂)₃), lithium chloride (LiCl), lithium bromide (LiBr) and the like are cited. Thereby, superior capacity, superior cycle characteristics, and superior storage characteristics are obtained. Specially, lithium hexafluorophosphate is preferable, since the internal resistance is lowered, and thus higher effects are obtained.

The content of the electrolyte salt is preferably in the range from 0.3 mol/kg to 3.0 mol/kg to the solvent. In the case that the content is out of the range, the ion conductivity is lowered and thus there is a possibility that a sufficient battery capacity may not be obtained.

In the secondary battery, when charged, for example, lithium ions are extracted from the cathode 21 and inserted in the anode 22 through the electrolytic solution impregnated in the separator 23. Meanwhile, when discharged, for example, lithium ions are extracted from the anode 22 and inserted in the cathode 21 through the electrolytic solution impregnated in the separator 23.

The secondary battery may be manufactured, for example, by the following procedure.

First, the cathode 21 is formed by forming the cathode active material layer 21B on the both faces of the cathode current collector 21A. When the cathode active material layer 21B is formed, for example, cathode active material powder, an electrical conductor, and a binder are mixed to prepare a cathode mixture, which is dispersed in a solvent to form paste cathode mixture slurry. Subsequently, the cathode current collector 21A is uniformly coated with the cathode mixture slurry. After the resultant is dried, the resultant is compression-molded by a rolling press machine.

Further, the anode 22 is formed by forming the anode active material layer 22B on the both faces of the anode current collector 22A, and then forming the coat 22C on the anode active material layer 22B. When the anode active material layer 22B is formed, for example, the anode active material is deposited on the anode current collector 22A by using vapor-phase deposition method. When the coat 22C is formed, for example, as a solution containing the metal salt having sulfur and oxygen, an aqueous solution in which the metal salt is dissolved is prepared. The anode current collector 22A on which the anode active material layer 22B is formed is dipped into the solution for several seconds and then pulled out and dried at room temperature. Otherwise, the foregoing solution is prepared, and the surface of the anode active material layer 22B is coated with the solution. After that, the resultant is dried.

Next, the cathode lead 25 is attached to the cathode current collector 21A by welding, and the anode lead 26 is attached to the anode current collector 22A by welding. After that, the cathode 21 and the anode 22 are spirally wound with the separator 23 in between to form the spirally wound electrode body 20. Subsequently, the end of the cathode lead 25 is welded to the safety valve mechanism 15, and the end of the anode lead 26 is welded to the battery can 11. After that, while the spirally wound electrode body 20 is sandwiched between the pair of insulating plates 12 and 13, the spirally wound electrode body 20 is contained in the battery can 11. Subsequently, the electrolytic solution is injected into the battery can 11, and impregnated in the separator 23. Finally, the battery cover 14, the safety valve mechanism 15, and the PTC device 16 are fixed at the open end of the battery can 11 by being caulked with the gasket 17. The secondary battery is thereby fabricated.

According to the anode and the method of manufacturing it and the cylindrical type secondary battery using it and the method of manufacturing it of this embodiment, before charge and discharge, the coat 22C containing the metal salt having sulfur and oxygen is formed on the anode active material layer 22B. At least one peak of ions selected from the group consisting of positive secondary ions (Li₃SO₄+, Li₃SO₃+, Li₂SO₃+, and Li₂SO₂+) and negative secondary ions (LiSO₄−, LiSO₃−, SO₃−, and SO₂−) is obtained by the surface analysis of the anode 22 using TOF-SIMS. Thereby, compared to a case that the coat 22C is not formed, the chemical stability of the anode 22 is improved and the decomposition reaction of the electrolytic solution is inhibited. Thus, even when charge and discharge are repeated, the electrolytic solution is hardly decomposed. Therefore, the cycle characteristics are improved.

In this case, since the coat 22C is formed by using the solution containing the metal salt having sulfur and oxygen, specifically, since the simple treatment such as dipping treatment and coating treatment using the foregoing solution is used, the favorable coat 22C may be formed more easily than in a case using a method necessitating particular environmental conditions such as reduced pressure environment.

In particular, since the coat 22C is formed on the anode active material layer 22B before charge and discharge, the fixing characteristics, the physical durability and the like of the coat 22C are improved more than in a case that the coat 22C is formed in charge and discharge. Thus, the cycle characteristics are further improved. Further, when the coat 22C is formed by using the aqueous solution as the foregoing solution, resistance to solubility of the coat 22C is improved in the case of being used in combination with the nonaqueous solvent-based electrolytic solution. Accordingly, the cycle characteristics are further improved.

A description will be given of structural characteristics of the foregoing secondary battery. That is, in the foregoing secondary battery, as shown in FIG. 2 and FIG. 3, the coat 22C is formed in the step of forming the anode 22, and the coat 22C is already formed in a stage before charging and discharging the secondary battery. In this case, as shown in FIG. 3, when the anode active material layer 22B and the coat 22C are formed over the whole area of the anode current collector 22A (both regions R1 and R2), the coat 22C should remain in the both regions R1 and R2 even after charge and discharge.

### Second Embodiment

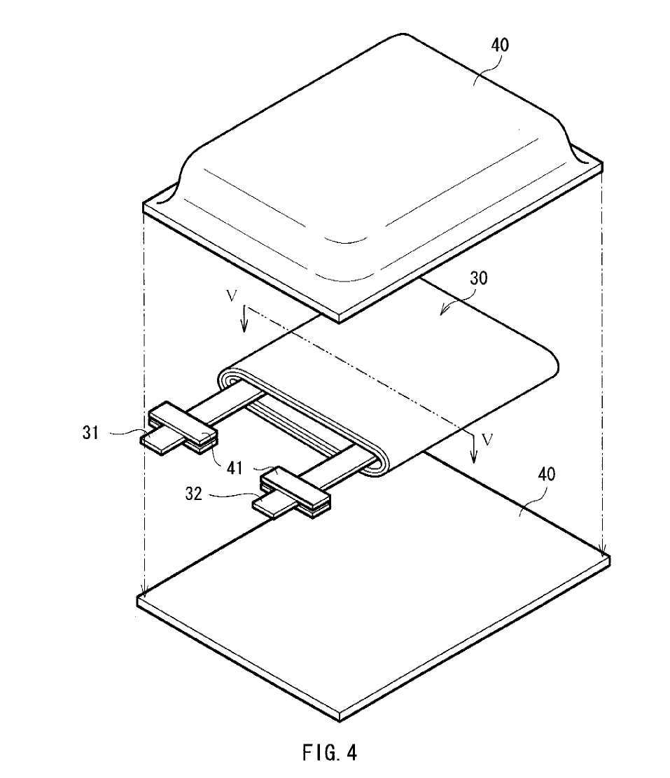

FIG. 4 shows an exploded perspective structure of a battery according to a second embodiment of the invention. In the battery, mainly, a spirally wound electrode body 30 to which a cathode lead 31 and an anode lead 32 are attached is contained in a film package member 40. The battery is a lithium ion secondary battery as in the first embodiment. The battery structure using the film package member 40 is called laminated film type.

The cathode lead 31 and the anode lead 32 are respectively derived in the same direction from inside to outside of the package member 40. The cathode lead 31 is made of, for example, a metal material such as aluminum, and the anode lead 32 is made of, for example, a metal material such as copper, nickel, and stainless. The metal material composing the cathode lead 31 and the anode lead 32 is in the shape of, for example, a thin plate or mesh.

The package member 40 is made of a rectangular aluminum laminated film in which, for example, a nylon film, an aluminum foil, and a polyethylene film are bonded together in this order. In the package member 40, for example, the polyethylene film and the spirally wound electrode body 30 are opposed to each other, and the respective outer edges are contacted to each other by fusion bonding or an adhesive. Adhesive films 41 to protect from entering of outside air are inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The package member 40 may be made of a laminated film having other structure, a polymer film made of polypropylene or the like, or a metal film, instead of the foregoing three-layer aluminum laminated film.

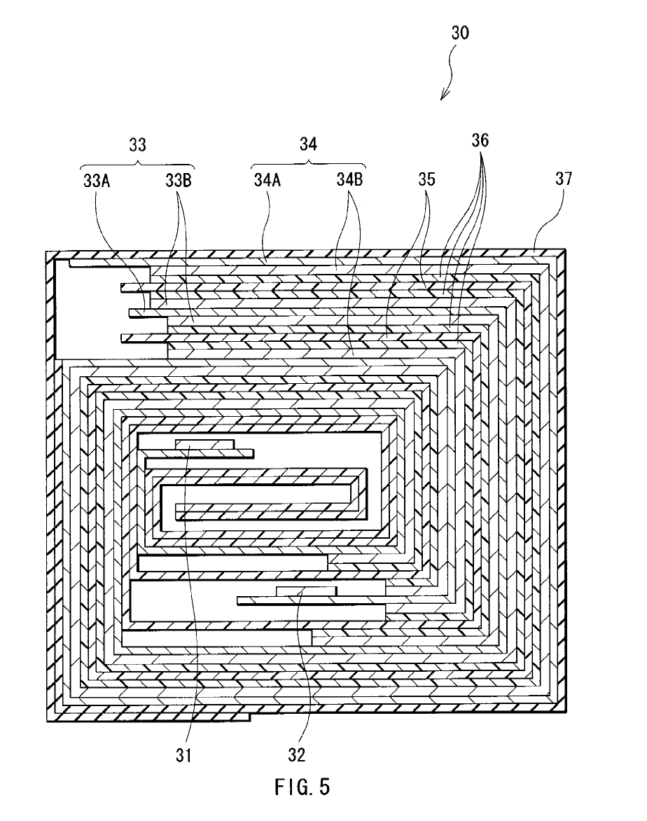

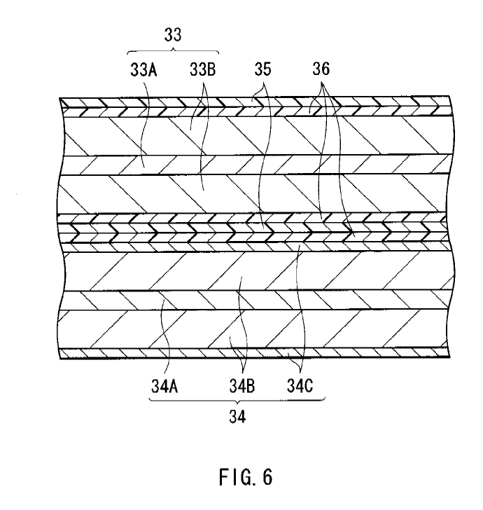

FIG. 5 shows a cross sectional structure taken along line V-V of the spirally wound electrode body 30 shown in FIG. 4. FIG. 6 shows an enlarged part of the spirally wound electrode body 30 shown in FIG. 5. In the spirally wound electrode body 30, a cathode 33 and an anode 34 are layered with a separator 35 and an electrolyte 36 in between and then spirally wound. The outermost periphery thereof is protected by a protective tape 37.

The cathode 33 has, for example, a structure in which a cathode active material layer 33B is provided on the both faces of a cathode current collector 33A. The anode 34 has, for example, a structure in which an anode active material layer 34B and a coat 34C are provided on the both faces of an anode current collector 34A. Structures of the cathode current collector 33A, the cathode active material layer 33B, the anode current collector 34A, the anode active material layer 34B, the coat 34C, and the separator 35 are respectively similar to those of the cathode current collector 21A, the cathode active material layer 21B, the anode current collector 22A, the anode active material layer 22B, the coat 22C, and the separator 23 in the first embodiment.

The electrolyte 36 is so-called gelatinous, containing an electrolytic solution and a polymer compound that holds the electrolytic solution. The gel electrolyte is preferable, since a high ion conductivity (for example, 1 mS/cm or more at room temperature) is thereby obtained, and leakage of the battery is thereby prevented.

As the polymer compound, for example, an ether polymer compound such as polyethylene oxide and a cross-linked body containing polyethylene oxide, an ester polymer compound such as polymethacrylate or an acrylate polymer compound, or a polymer of vinylidene fluoride such as polyvinylidene fluoride and a copolymer of vinylidene fluoride and hexafluoropropylene are cited. One thereof may be used singly, or a plurality thereof may be used by mixture. In particular, in terms of redox stability, the fluorinated polymer compound such as the polymer of vinylidene fluoride or the like is preferable. The additive amount of the polymer compound in the electrolytic solution varies according to compatibility therebetween, but is preferably in the range from 5 wt % to 50 wt %.

The composition of the electrolytic solution is similar to the composition of the electrolytic solution in the foregoing first embodiment. However, the solvent in this embodiment means a wide concept including not only the liquid solvent but also a solvent having ion conductivity capable of dissociating the electrolyte salt. Therefore, when the polymer compound having ion conductivity is used, the polymer compound is also included in the solvent.

Instead of the electrolyte 36 in which the electrolytic solution is held by the polymer compound, the electrolytic solution may be directly used. In this case, the electrolytic solution is impregnated in the separator 35.

In the secondary battery, when charged, for example, lithium ions are extracted from the cathode 33 and inserted in the anode 34 through the electrolyte 36. Meanwhile, when discharged, lithium ions are extracted from the anode 34 and inserted in the cathode 33 through the electrolyte 36.

The secondary battery including the gel electrolyte 36 may be manufactured, for example, by the following three manufacturing methods.

In the first manufacturing method, first, the cathode 33 is formed by forming the cathode active material layer 33B on the both faces of the cathode current collector 33A, and the anode 34 is formed by forming the anode active material layer 34B and the coat 34C on the both faces of the anode current collector 34A by a procedure similar to that of the manufacturing method in the first embodiment. Subsequently, a precursor solution containing an electrolytic solution, a polymer compound, and a solvent is prepared. After the cathode 33 and the anode 34 are coated with the precursor solution, the solvent is volatilized to form the gel electrolyte 36. Subsequently, the cathode lead 31 and the anode lead 32 are respectively attached to the cathode current collector 33A and the anode current collector 34A. Subsequently, the cathode 33 and the anode 34 formed with the electrolyte 36 are layered with the separator 35 in between to obtain a laminated body. After that, the laminated body is spirally wound in the longitudinal direction, the protective tape 37 is adhered to the outermost periphery thereof to form the spirally wound electrode body 30. Finally, for example, after the spirally wound electrode body 30 is sandwiched between two pieces of the film package members 40, outer edges of the package members 40 are contacted by thermal fusion bonding or the like to enclose the spirally wound electrode body 30. Then, the adhesive films 41 are inserted between the cathode lead 31, the anode lead 32 and the package member 40. Thereby, the secondary battery is fabricated.

In the second manufacturing method, first, the cathode lead 31 and the anode lead 32 are respectively attached to the cathode 33 and the anode 34. After that, the cathode 33 and the anode 34 are layered with the separator 35 in between and spirally wound. The protective tape 37 is adhered to the outermost periphery thereof, and thereby a spirally wound body as a precursor of the spirally wound electrode body 30 is formed. Subsequently, after the spirally wound body is sandwiched between two pieces of the film package members 40, the outermost peripheries except for one side are thermally fusion-bonded to obtain a pouched state, and the spirally wound body is contained in the pouch-like package member 40. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 40. After that, the opening of the package member 40 is hermetically sealed by thermal fusion bonding or the like. Finally, the monomer is thermally polymerized to obtain a polymer compound. Thereby, the gel electrolyte 36 is formed. Accordingly, the secondary battery is fabricated.

In the third manufacturing method, first, the spirally wound body is formed and contained in the pouch-like package member 40 in the same manner as that of the foregoing first manufacturing method, except that the separator 35 with the both faces coated with a polymer compound is used. As the polymer compound with which the separator 35 is coated, for example, a polymer containing vinylidene fluoride as a component, that is, a homopolymer, a copolymer, a multicomponent copolymer and the like are cited. Specifically, polyvinylidene fluoride, a binary copolymer containing vinylidene fluoride and hexafluoropropylene as a component, a ternary copolymer containing vinylidene fluoride, hexafluoropropylene, and chlorotrifluoroethylene as a component and the like are cited. As a polymer compound, in addition to the foregoing polymer containing vinylidene fluoride as a component, another one or more polymer compounds may be used. Subsequently, an electrolytic solution is prepared and injected into the package member 40. After that, the opening of the package member 40 is sealed by thermal fusion bonding or the like. Finally, the resultant is heated while a weight is applied to the package member 40, and the separator 35 is contacted to the cathode 33 and the anode 34 with the polymer compound in between. Thereby, the electrolytic solution is impregnated into the polymer compound, and the polymer compound is gelated to form the electrolyte 36. Accordingly, the secondary battery is fabricated.

In the third manufacturing method, the swollenness characteristics are improved compared to the first manufacturing method. Further, in the third manufacturing method, the monomer as a raw material of the polymer compound, the solvent and the like hardly remain in the electrolyte 36 compared to in the second manufacturing method, and the steps of forming the polymer compound are favorably controlled. Thus, sufficient contact characteristics are obtained between the cathode 33/the anode 34/the separator 35 and the electrolyte 36.

According to the anode and the method of manufacturing it and the laminated film type secondary battery using it and the method of manufacturing it of this embodiment, the anode 34 has the structure similar to that of the anode 22 of the first embodiment described above. Thus, the cycle characteristics are improved. Other action and other effect are similar to those of the foregoing first embodiment.

### Third Embodiment

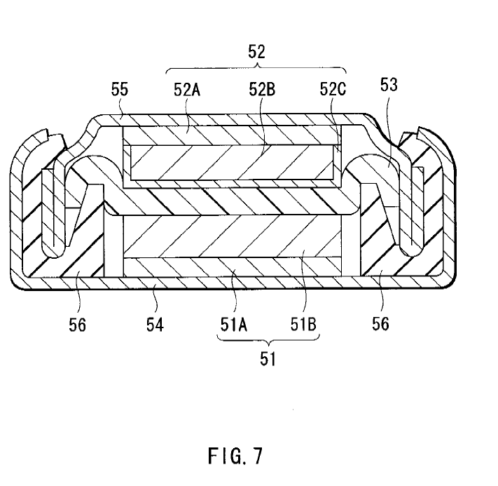

FIG. 7 shows a cross sectional structure of a battery according to a third embodiment of the invention. In the secondary battery, a cathode 51 is contained in a package can 54 and an anode 52 is bonded to a package cup 55, the resultant is layered with a separator 53 impregnated with an electrolytic solution in between, and the resultant laminated body is caulked with a gasket 56. The secondary battery is, for example, a lithium ion secondary battery as in the foregoing first embodiment. The battery structure using the package can 54 and the package cup 55 is called coin type.

The structures of the package can 54, the package cup 55, and the gasket 56 are respectively similar to the structures of the battery can 11 and the gasket 17 in the foregoing first embodiment.

The cathode 51 has, for example, a structure in which a cathode active material layer 51B is provided on a single face of a cathode current collector 61A. The anode 52 has, for example, a structure in which an anode active material layer 52B and a coat 52C are provided on an anode current collector 52A. Structures of the cathode current collector 61A, the cathode active material layer 51B, the anode current collector 52A, the anode active material layer 52B, the coat 52C, the separator 53, and the electrolytic solution are respectively similar to those of the cathode current collector 21A, the cathode active material layer 21B, the anode current collector 22A, the anode active material layer 22B, the coat 22C, the separator 23, and the electrolytic solution in the foregoing first embodiment.

The secondary battery may be manufactured by the following procedure, for example. First, the cathode 51 is formed by forming the cathode active material layer 51B on the cathode current collector 61A, and the anode 52 is formed by forming the anode active material layer 52B and the coat 52C on the anode current collector 52A by a procedure similar to that of the manufacturing method in the foregoing first embodiment. Subsequently, the cathode 51 and the anode 52 are punched out into a pellet having a given diameter. Finally, the cathode 51 is contained in the package can 54 and the anode 52 is bonded to the package cup 55, the resultant is layered with the separator 53 impregnated with an electrolytic solution in between, and the laminated body is caulked with the gasket 56. Thereby, the secondary battery is fabricated.

According to the anode and the method of manufacturing it and the coin type secondary battery using it and the method of manufacturing it of this embodiment, the anode 52 has the structure similar to that of the anode 22 of the foregoing first embodiment. Thus, the cycle characteristics are improved. Other action and other effect are similar to those of the foregoing first embodiment.

### Fourth Embodiment

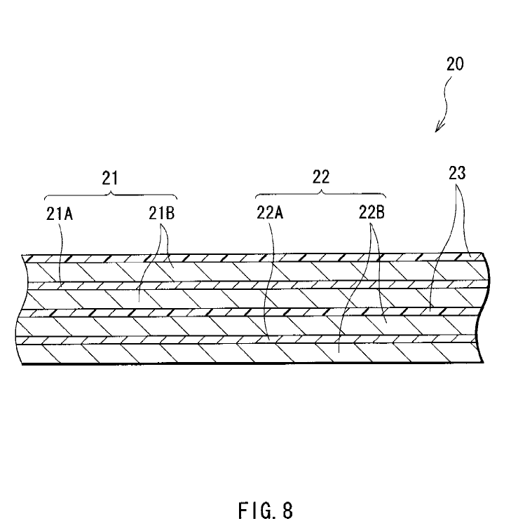

FIG. 8 is a cross sectional structure of the main part of a battery according to a fourth embodiment of the invention, and corresponds to FIG. 2. In the battery, the coat 22C is formed on the anode active material layer 22B in charge and discharge, differently from the battery of the first embodiment in which the coat 22C is already formed on the anode active material layer 22B before charge and discharge. The battery is the cylindrical type lithium ion secondary battery having the same structure as that of the battery of the first embodiment, except for the following description.

In the secondary battery, the electrolytic solution contains a compound having a sulfonyl group (>SO₂) instead of forming the coat 22C on the anode active material layer 22B in a stage before charge and discharge. The compound having a sulfonyl group is decomposed in charge and discharge, and thereby the coat 22C is formed on the anode active material layer 22B subsequently. The number of sulfonyl groups may be one or more. Further, the concentration of the compound having a sulfonyl group in the electrolytic solution may be voluntarily set.

The compound having a sulfonyl group may have any structure as long as the compound has the sulfonyl group, but is preferably an acid anhydride. Since the acid anhydride has resistance to reduction, the cycle characteristics and the swollenness characteristics are thereby improved. As the compound having a sulfonyl group, for example, compounds shown in Chemical formula 1, Chemical formula 2, and Chemical formula 3 are cited. Of the foregoing, the compounds shown in Chemical formula 1 and Chemical formula 2 are a sulfonic acid/carboxylic acid anhydride, and the compound shown in Chemical formula 3 is a disulfonic acid anhydride. These compounds may be used singly, or a plurality thereof may be used by mixture.

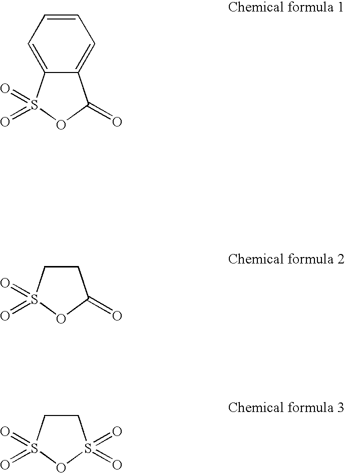

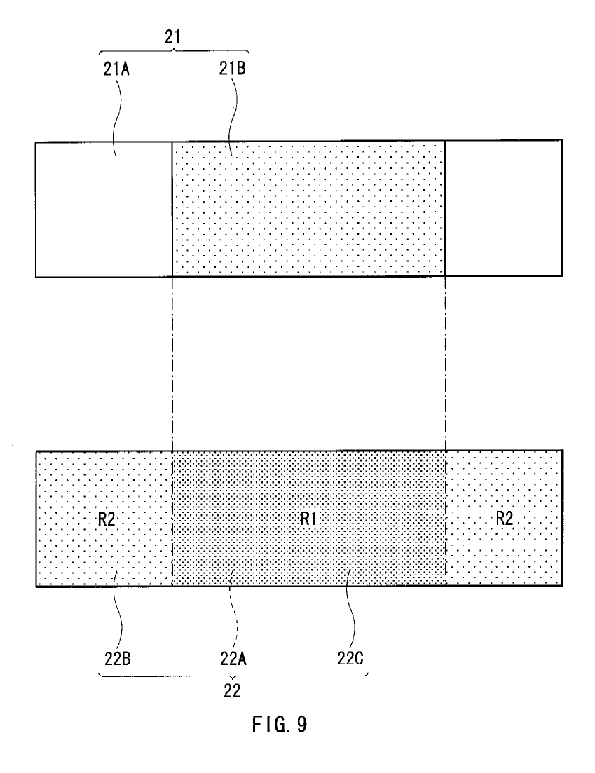

FIG. 9 shows a planar structure of the cathode 21 and the anode 22, and corresponds to FIG. 3. In FIG. 9, the range of forming the cathode active material layer 21B of the cathode 21 is provided with faint half-tone dot meshing, the range of forming the anode active material layer 22B of the anode 22 is provided with faint half-tone dot meshing, and the coat 22C of the anode 22 is provided with dark half-tone dot meshing.

In the secondary battery, for example, in the anode 22, the anode active material layer 22B is provided in the regions R1 and R2, while the coat 22C is provided only in the region R1, since the coat 22C is formed only in a region where electrode reaction proceeds (region R1) in charge and discharge. However, the range of forming the coat 22C is not necessarily limited to only the region R1. Part of the coat 22C may be also formed in the region R2 in the vicinity of the interface with the region R1 depending on charge and discharge conditions (for example, current density) and the like.

In the secondary battery, when charge and discharge are performed, the compound having a sulfonyl group in the electrolytic solution is decomposed. Thus, as shown in FIG. 2, the coat 22C containing the metal salt having sulfur and oxygen is formed on the anode active material layer 22B. The sufficient number of charges and discharges needed for forming the coat 22C is at least one. In the result, at least one peak of ions selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion is obtained by the surface analysis of the anode 22 using TOF-SIMS after charge and discharge. In this case, when Bi₃+ (9.7952×10¹¹ ions/cm²) is applied as a primary ion, the counting of the detection amount of Li₃SO₄+ is preferably 10000 or more, and the counting of the detection amount of Li₃SO₃+ is preferably 9000 or more.

The secondary battery may be manufactured by a procedure similar to that of the manufacturing method of the foregoing first embodiment, except that the compound having a sulfonyl group is contained in the electrolytic solution instead of forming the coat 22C on the anode active material layer 22B.

According to the anode and the method of manufacturing it and the cylindrical type secondary battery using it and the method of manufacturing it of this embodiment, the electrolytic solution contains the compound having a sulfonyl group. Thus, when charge and discharge are performed, the coat 22C is formed on the anode active material layer 22B. In addition, at least one peak of ions selected from the group consisting of positive secondary ions (Li₃SO₄+, Li₃SO₃+, Li₂SO₃+, and Li₂SO₂+) and negative secondary ions (LiSO₄−, LiSO₃−, SO₃−, and SO₂−) is obtained by the surface analysis of the anode 22 using TOF-SIMS after charge and discharge. Therefore, due to an action similar to that of the battery of the first embodiment, the cycle characteristics are improved. Action and effect other than the foregoing description are similar to those of the battery of the first embodiment.

A description will be given of structural characteristics of the foregoing secondary battery. That is, in the foregoing secondary battery, as shown in FIG. 9, the coat 22C is not formed in the step of forming the anode 22, and the coat 22C is formed in charging and discharging the secondary battery for the first time. In this case, even when the anode active material layer 22B is formed on the whole area of the anode current collector 22A (both regions R1 and R2), the coat 22C should exist only in the region R1.

### Fifth Embodiment

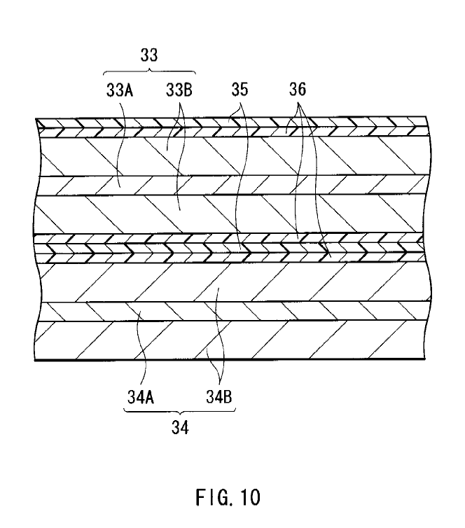

FIG. 10 is a cross sectional structure of the main part of a battery according to a fifth embodiment of the invention, and corresponds to FIG. 6. The battery is the laminated film type lithium ion secondary battery having a structure similar to that of the battery of the second embodiment, except that the coat 34C is not formed on the anode active material layer 34B before charge and discharge and the coat 34C is formed on the anode active material layer 34 in charge and discharge as in the forth embodiment, and may be manufactured by a procedure similar to that of the manufacturing method of the second embodiment.

In the secondary battery, since the electrolytic solution contains a compound having a sulfonyl group as in the forth embodiment, when charge and discharge are performed, the coat 34C is formed on the anode active material layer 34B as shown in FIG. 6.

According to the anode and the method of manufacturing it and the laminated film type secondary battery using it and the method of manufacturing it of this embodiment, the electrolytic solution contains the compound having a sulfonyl group. Thus, when charge and discharge are performed, the coat 34C is formed on the anode active material layer 34B. In addition, at least one peak of ions selected from the group consisting of positive secondary ions (Li₃SO₄+, Li₃SO₃+, Li₂SO₃+, and Li₂SO₂+) and negative secondary ions (LiSO₄−, LiSO₃−, SO₃−, and SO₂−) is obtained by the surface analysis of the anode 22 using TOF-SIMS after charge and discharge. Therefore, due to an action similar to that of the first embodiment, the cycle characteristics are improved. Action and effect other than the foregoing description are similar to those of the battery of the first embodiment.

### Sixth Embodiment

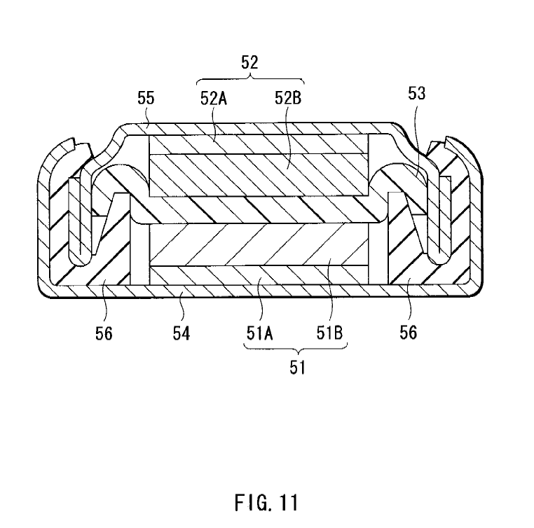

FIG. 11 shows a cross sectional structure of a battery according to a sixth embodiment of the invention, and corresponds to FIG. 7. The battery is the coin type lithium ion secondary battery having a structure similar to that of the battery of the third embodiment, except that the coat 52C is not formed on the anode active material layer 52B before charge and discharge and the coat 52C is formed on the anode active material layer 52B in charge and discharge as in the forth embodiment, and may be manufactured by a procedure similar to that of the manufacturing method of the third embodiment.

In the secondary battery, since the electrolytic solution contains the compound having a sulfonyl group as in the forth embodiment, when charge and discharge are performed, the coat 52C is formed on the anode active material layer 52B as shown in FIG. 7.

According to the anode and the method of manufacturing it and the coin type secondary battery using it and the method of manufacturing it of this embodiment, the electrolytic solution contains the compound having a sulfonyl group. Thus, when charge and discharge are performed, the coat 52C is formed on the anode active material layer 52B. In addition, at least one peak of ions selected from the group consisting of positive secondary ions (Li₃SO₄+, Li₃SO₃+, Li₂SO₃+, and Li₂SO₂+) and negative secondary ions (LiSO₄−, LiSO₃−, SO₃−, and SO₂−) is obtained by the surface analysis of the anode 22 using TOF-SIMS after charge and discharge. Therefore, due to an action similar to that of the first embodiment, the cycle characteristics are improved. Action and effect other than the foregoing description are similar to those of the battery of the first embodiment.

### EXAMPLES

Specific examples of the invention will be described in detail.

### Example 1-1

As a representative of the foregoing batteries, the coin type lithium ion secondary battery shown in FIG. 7 was fabricated by the method of manufacturing a battery in the third embodiment.

First, the cathode 51 was formed. First, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium cobalt complex oxide (LiCoO₂) was obtained. Subsequently, 91 parts by weight of the lithium cobalt complex oxide as a cathode active material, 6 parts by weight of graphite as an electrical conductor, and 3 parts by weight of polyvinylidene fluoride as a binder were mixed to obtain a cathode mixture. After that, the cathode mixture was dispersed in N-methyl-2-pyrrolidone to obtain paste cathode mixture slurry. Subsequently, the cathode current collector 51A made of an aluminum foil (thickness: 20 μm) was uniformly coated with the cathode mixture slurry, which was dried. After that, the resultant was compression-molded by a rolling press machine to form the cathode active material layer 51B. Finally, the cathode current collector 51A on which the cathode active material layer 51B was formed was punched out into a pellet having a diameter of 15.5 mm.

Next, the anode 52 was formed. First, the anode active material layer 52B was formed by depositing silicon on the anode current collector 52A made of a copper foil (thickness: 10 μm) by using electron beam evaporation method. Subsequently, the anode current collector 52A on which the anode active material layer 52B was formed was punched out into a pellet having a diameter of 16 mm. Subsequently, 2% aqueous solution of lithium sulfate was prepared as a solution containing the metal salt having sulfur and oxygen. After that, the pellet was dipped in the solution for several seconds. Finally, the pellet was pulled out from the solution, dried to form the coat 52C.

Next, the cathode 51, the anode 52, and the separator 53 made of a microporous polypropylene film were layered so that the cathode active material layer 51B and the anode active material layer 52B were opposed with the separator 53 in between, and then the resultant laminated body was contained in the package can 54. Subsequently, ethylene carbonate (EC) and diethyl carbonate (DEC) as a solvent were mixed to obtain a mixture. After that, lithium hexafluorophosphate as an electrolyte salt was dissolved in the mixture to prepare an electrolytic solution. The solvent composition was EC:DEC=30:70 at a weight ratio, and the concentration of lithium hexafluorophosphate in the electrolytic solution was 1 mol/kg. Finally, after the electrolytic solution was injected and impregnated into the separator 53, the package cup 55 was put thereon and the resultant was caulked with the gasket 56. Accordingly, the coin type secondary battery was fabricated.

### Examples 1-2 to 1-7

A procedure was performed in the same manner as that of Example 1-1, except that as the metal salt having sulfur and oxygen, lithium subsulfate (Example 1-2), lithium thiosulfate (Example 1-3), a mixture of lithium sulfate and lithium subsulfate (Example 1-4), a mixture of lithium sulfate and lithium thiosulfate (Example 1-5), a mixture of lithium subsulfate and lithium thiosulfate (Example 1-6), or a mixture of lithium sulfate, lithium subsulfate, and lithium thiosulfate (Example 1-7) was used. The composition of the mixtures was 1:1 for the two-component mixtures, and 1:1:1 for the three-component mixtures.

### Comparative Example 1

A procedure was performed in the same manner as that of Example 1-1, except that the coat 52C was not formed.

When the cycle characteristics of the secondary batteries of Examples 1-1 to 1-7 and Comparative example 1 were examined, the results shown in Table 1 were obtained.

In examining the cycle characteristics, charge and discharge were performed 2 cycles in the atmosphere at 23 deg C. to measure the discharge capacity, and then charge and discharge were continuously performed in the same atmosphere until the total number of cycles was 100 cycles to measure the discharge capacity. After that, the discharge capacity retention ratio (%)=(discharge capacity at the 100th cycle/discharge capacity at the second cycle)×100 was calculated. As charge and discharge conditions of 1 cycle, charge was performed at the constant current density of 1 mA/cm² until the battery voltage reached 4.2 V, charge was continuously performed at the constant voltage of 4.2 V until the current density reached 0.02 mA/cm². After that, discharge was performed at the constant current density of 1 mA/cm² until the battery voltage reached 2.5 V.

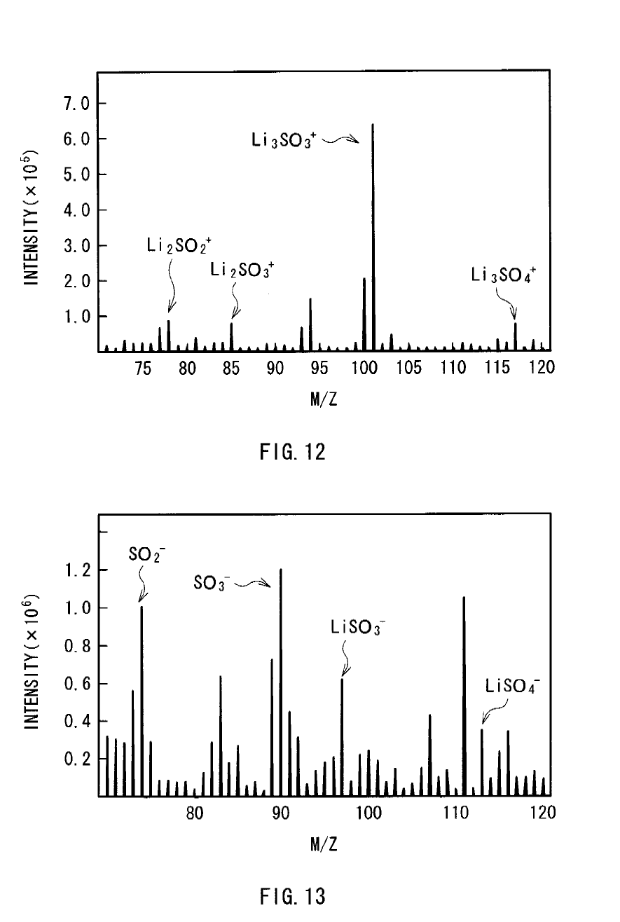

When the cycle characteristics were examined, as a representative of positive secondary ions, the detection amounts (counting of ions) of Li₃SO₄+ and Li₃SO₃+ were also examined by surface analysis of the anode 52 using TOF-SIMS. As an analysis equipment, TOF-SIMS V (manufactured by ION-TOF GmbH) was used. As the analysis conditions, the primary ion was Bi₃+ (9.7952×10¹¹ ions/cm²), the accelerating voltage of the ion gun was 25 keV, the analysis mode was bunching mode, the current of irradiated ion (measurement with pulsed beam) was 0.3 pA, the pulse frequency was 10 kHz, the weight range was from 1 amu to 800 amu, the scanning range was 200 μm×200 μm, and the weight resolution M/AM was 6800 (C₂H₅+) and 5900 (CH₂−). For reference, FIG. 12 and FIG. 13 show the surface analysis results of the secondary battery of Example 1-7 using TOF-SIMS, and show the analysis result of positive secondary ions and the analysis result of negative secondary ions, respectively.

The foregoing procedure and the foregoing conditions for examining the cycle characteristics and the like were similarly applied to the following examples and comparative examples.

TABLE 1

| | Anode active | | Detection amount of | | Discharge |
|---|---|---|---|---|---|
| | material layer | | positive secondary | | capacity |
| | (forming | | ion (counting) | | retention ratio |
| | method) | Coat | Li₃SO₄⁺ | Li₃SO₃⁺ | (%) |
| Example 1-1 | Silicon | Li₂SO₄ | 678580 | 85037 | 79 |
| Example 1-2 | (evaporation | Li₂SO₃ | 51021 | 1642011 | 80 |
| Example 1-3 | method) | Li₂S₂O₃ | 10000 | 9000 | 77 |
| Example 1-4 | | Li₂SO₄ + Li₂SO₃ | 530922 | 901103 | 81 |
| Example 1-5 | | Li₂SO₄ + Li₂S₂O₃ | 239424 | 10833 | 80 |
| Example 1-6 | | Li₂SO₃ + Li₂S₂O₃ | 11904 | 739821 | 79 |
| Example 1-7 | | Li₂SO₄ + Li₂SO₃ + Li₂S₂O₃ | 399810 | 865498 | 83 |
| Comparative | Silicon | — | — | — | 27 |
| example 1 | (evaporation | | | | |
| | method) | | | | |

As shown in Table 1, in Examples 1-1 to 1-7 in which the coat 52C was formed, the discharge capacity retention ratio was largely increased more than in Comparative example 1 in which the coat 52C was not formed. In this case, focusing attention on the type of coat 52C, the discharge capacity retention ratio tended to be increased in the order of lithium thiosulfate, lithium sulfate, and lithium subsulfate.

In particular, in Examples 1-1 to 1-7, as shown in Table 1, FIG. 12, and FIG. 13, positive secondary ions (Li₃SO₄+, Li₃SO₃+, Li₂SO₃+, and Li₂SO₂+ and negative secondary ions (LiSO₄−, LiSO₃−, SO₃−, and SO₂−) were obtained by surface analysis using TOF-SIMS. In this case, the counting of the detection amount of Li₃SO₄+ was 10000 or more, and the counting of the detection amount of Li₃SO₃+ was 9000 or more. Meanwhile, in Comparative example 1 in which the coat 52C was not formed, positive secondary ions were not obtained by surface analysis using TOF-SIMS.

Accordingly, in the secondary battery of the invention, it was confirmed that the cycle characteristics were improved when the coat containing the metal salt having sulfur and oxygen was formed on the anode active material layer in the case that the anode contained silicon (evaporation method) as an anode active material. In this case, it is preferable that positive secondary ions and negative secondary ions were obtained by surface analysis of the anode using TOF-SIMS, the counting of the detection amount of Li₃SO₄+ was 10000 or more, and the counting of the detection amount of Li₃SO₃+ was 9000 or more. Further, when lithium subsulfate was used as the metal salt having sulfur and oxygen, the cycle characteristics were further improved.

### Examples 2-1 and 2-2

A procedure was performed in the same manner as that of Examples 1-2 and 1-7, except that the anode active material layer 52B was formed by using sintering method. When the anode active material layer 52B was formed, 90 parts by weight of silicon powder (average particle diameter: 1 μm) as an anode active material and 10 parts by weight of polyvinylidene fluoride as a binder were mixed to obtain an anode mixture. After that, the anode mixture was dispersed in N-methyl-2-pyrrolidone to obtain paste anode mixture slurry. Subsequently, the anode current collector 52A was uniformly coated with the anode mixture slurry, which was dried. After that, the resultant was compression-molded by a rolling press machine and then heated at 400 deg C. for 12 hours.

### Comparative Example 2

A procedure was performed in the same manner as that of Comparative example 1, except that the anode active material layer 52B was formed by using sintering method as in Examples 2-1 and 2-2.

When the cycle characteristics and the like of the secondary batteries of Examples 2-1 and 2-2 and Comparative example 2 were examined, the results shown in Table 2 were obtained.

TABLE 2

| | | | Detection amount | | |
|---|---|---|---|---|---|
| | Anode active | | of positive | | Discharge |
| | material layer | | secondary ion | | capacity |
| | (forming | | (counting) | | retention ratio |
| | method) | Coat | Li₃SO₄⁺ | Li₃SO₃⁺ | (%) |
| Example 2-1 | Silicon | Li₂SO₃ | 48127 | 134215 | 40 |
| Example 2-2 | (sintering method) | Li₂SO₄ + Li₂SO₃ + Li₂S₂O₃ | 291832 | 714266 | 43 |
| Comparative | Silicon | — | — | — | 32 |
| example 1 | (sintering method) | | | | |

As shown in Table 2, results similar to the results of Table 1 were also obtained when the coat 52C was formed by using sintering method. That is, in Examples 2-1 and 2-2 in which the coat 52C was formed, the counting of the detection amount of Li₃SO₄+ was 10000 or more, the counting of the detection amount of Li₃SO₃+ was 9000 or more, and the discharge capacity retention ratio was higher than that of Comparative example 2 in which the coat 52C was not formed.

Accordingly, in the secondary battery of the invention, it was confirmed that the cycle characteristics were also improved when the anode contains silicon (sintering method) as an anode active material.

### Examples 3-1 and 3-2

A procedure was performed in the same manner as that of Examples 1-2 and 1-7, except that the anode active material layer 52B was formed by using a SnCoC-containing material as an anode active material. The procedure of forming the anode active material layer 52B was as follows.

First, the SnCoC-containing material was obtained. First, cobalt powder, tin powder, and indium powder were alloyed to obtain cobalt-tin-indium alloy powder, to which the carbon powder was added. The resultant was dry-blended. Subsequently, 20 g of the foregoing mixture together with about 400 g of a corundum having a diameter of 9 mm were set in a reactive vessel of a planetary ball mill of Ito Seisakusho CO., LTD. Subsequently, inside of the reactive vessel was substituted with argon atmosphere. After that, 10 minute operation at 250 rpm and 10 minute stop were repeated until the total operation time became 30 hours. Finally, the reactive vessel was cooled down to room temperature, and the synthesized SnCoC-containing material was taken out. After that, coarse grain was removed therefrom with the use of a 280-mesh sieve.

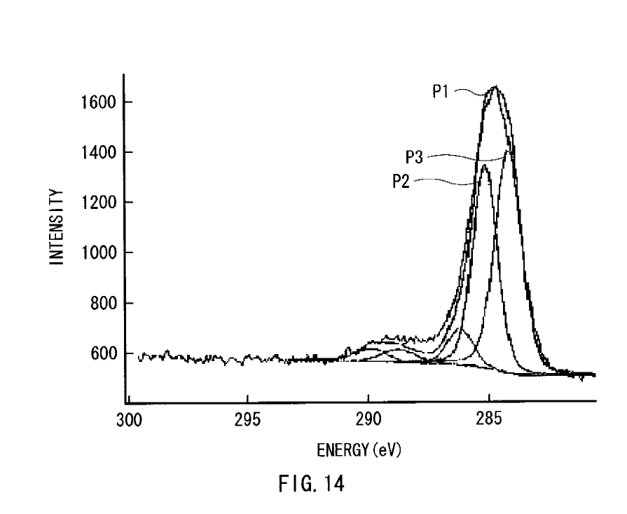

For the obtained SnCoC-containing material, the following various analyses were performed. First, when the composition of the SnCoC-containing material was analyzed, the tin content was 48 wt %, the cobalt content was 23 wt %, the carbon content was 20 wt %, and the cobalt ratio to the total of tin and cobalt was 32.4 wt %. At that time, the tin content and the cobalt content were measured by Inductively Coupled Plasma (ICP) optical emission spectroscopy. The carbon content was measured by a carbon sulfur analyzer. Secondary, the SnCoC-containing material was analyzed by X-ray diffraction method. In the result, the diffraction peak having the half-width in the range of the diffraction angle 2θ=20 to 50 degrees was observed. Thirdly, when the SnCoC-containing material was analyzed by XPS, Peak P1 was obtained as shown in FIG. 14. When Peak P1 was analyzed, Peak P2 of the surface contamination carbon and Peak P3 of C1s in the SnCoC-containing material on the energy side lower than that of Peak P2 (region lower than 284.5 eV) were obtained. That is, it was confirmed that carbon in the SnCoC-containing material was bonded to other element.

80 parts by weight of the SnCoC-containing material as the anode active material, 11 parts by weight of graphite and 1 part by weight of acetylene black as an electrical conductor, and 8 parts by weight of polyvinylidene fluoride as a binder were mixed to obtain an anode mixture. After that, the mixture was dispersed in N-methyl-2-pyrrolidone to obtain paste anode mixture slurry. After that, the anode current collector 52A was uniformly coated with the anode mixture slurry, which was dried and compression-molded by a rolling press machine to form the anode active material layer 52B.

### Comparative Example 3

A procedure was performed in the same manner as that of Comparative example 1, except that the anode active material layer 52B was formed by using the SnCoC-containing material as an anode active material as in Examples 3-1 and 3-2.

When the cycle characteristics and the like of the secondary batteries of Examples 3-1 and 3-2 and Comparative example 3 were examined, the results shown in Table 3 were obtained.

TABLE 3

| | | | Detection amount | | |
|---|---|---|---|---|---|
| | | | of positive | | Discharge |
| | Anode active | | secondary ion | | capacity |
| | material layer | | (counting) | | retention ratio |
| | (forming method) | Coat | Li₃SO₄⁺ | Li₃SO₃⁺ | (%) |
| Example 3-1 | SnCoC-containing | Li₂SO₃ | 19873 | 85331 | 53 |
| Example 3-2 | material | Li₂SO₄ + Li₂SO₃ + Li₂S₂O₃ | 98311 | 409831 | 56 |
| | (coating method) | | | | |
| Comparative | SnCoC-containing | — | — | — | 48 |
| example 3 | material | | | | |
| | (coating method) | | | | |

As shown in Table 3, results similar to the results of Table 1 were also obtained when the anode active material layer 52B was formed by using the SnCoC-containing material. That is, in Examples 3-1 and 3-2 in which the coat 52C was formed, the counting of the detection amount of Li₃SO₄+ was 10000 or more, the counting of the detection amount of Li₃SO₃+ was 9000 or more, and the discharge capacity retention ratio was higher than that of Comparative example 3 in which the coat 52C was not formed.

Accordingly, in the secondary battery of the invention, it was confirmed that the cycle characteristics were also improved when the anode contained the SnCoC-containing material as an anode active material.

### Examples 4-1

A procedure was performed in the same manner as that of Example 1-1, except that the coat 52C was formed on the anode active material layer 52B in charge and discharge by the manufacturing method of the sixth embodiment. In this case, instead of forming the coat 52C on the anode active material layer 52B before charge and discharge, the compound shown in Chemical formula 1 was added as a compound having a sulfonyl group to the electrolytic solution and thereby the coat 52C was subsequently formed on the anode active material layer 52B by using charge and discharge for examining the cycle characteristics. The content of the compound shown in Chemical formula 1 in the electrolytic solution was 1 wt %. “Wt %” means a value (ratio) where the entire solvent (excluding the compound shown in Chemical formula 1) is 100 wt %.

### Examples 4-2 and 4-3

A procedure was performed in the same manner as that of Example 4-1, except that the compound shown in Chemical formula 2 (Example 4-2) or the compound shown in Chemical formula 3 (Example 4-3) was used as a compound having a sulfonyl group.

When the cycle characteristics and the like of the secondary batteries of Examples 4-1 to 4-3 were examined, the results shown in Table 4 were obtained. Table 4 also shows the result of Comparative example 1.

TABLE 4

| | Anode | | Detection amount | | |
|---|---|---|---|---|---|
| | Anode active | | of positive | | Discharge |
| | material layer | Electrolytic solution | secondary ion | | capacity |
| | (forming | Compound having a | (counting) | | retention ratio |
| | method) | sulfonyl group | Li₃SO₄⁺ | Li₃SO₃⁺ | (%) |
| Example 4-1 | Silicon | Chemical formula 1 | 149608 | 1500449 | 74 |
| Example 4-2 | (evaporation | Chemical formula 2 | 184042 | 668580 | 80 |
| Example 4-3 | method) | Chemical formula 3 | 152287 | 163682 | 75 |
| Comparative | Silicon | — | — | — | 27 |
| example 1 | (evaporation | | | | |
| | method) | | | | |

As shown in Table 4, results similar to the results of Table 1 were also obtained when the coat 52C was formed in charge and discharge. That is, in Examples 4-1 to 4-3 in which the coat 52C was formed, the discharge capacity retention ratio was largely increased more than that of Comparative example 1 in which the coat 52C was not formed. Furthermore, as in the case shown in FIG. 13, positive secondary ions (Li₃SO₄+, Li₃SO₃+, Li₂SO₃+, and Li₂SO₂+) and negative secondary ions (LiSO₄−, LiSO₃−, SO₃−, and SO₂−) were obtained by the surface analysis using TOF-SIMS after charge and discharge, and the counting of the detection amount of Li₃SO₄+ was 10000 or more and the counting of the detection amount of Li₃SO₃+ was 9000 or more.

Accordingly, in the secondary battery of the invention, it was confirmed that the cycle characteristics were improved for the following reason. That is, when the electrolytic solution contained the compound having a sulfonyl group in the case that the anode contained silicon as an anode active material, the coat containing the metal salt having sulfur and oxygen was formed on the anode active material layer in charge and discharge, and at least one peak of ions selected from the group consisting of the positive secondary ions and the negative secondary ions is obtained by surface analysis of the anode using TOF-SIMS after charge and discharge. In this case, it is preferable that the counting of the detection amount of Li₃SO₄+ was 10000 or more, and the counting of the detection amount of Li₃SO₃+ was 9000 or more.

In Table 4, no example in which the electrolytic solution contains a compound having a sulfonyl group in the case that the anode contains the SnCoC-containing material as an anode active material is disclosed. However, it is evident from the results of Table 1 to Table 3 that when the coat is provided on the anode active material layer, the cycle characteristics are improved not depending on the type of anode active material. Thus, it is evident that the cycle characteristics are also improved when the SnCoC-containing material and the compound having a sulfonyl group are used together.

When comparing the results of Table 1 to Table 3 in which the coat 52C was formed before charge and discharge to the results of Table 4 in which the coat 52C was formed in charge and discharge, the discharge capacity retention ratio of the former tended to be higher than that of the latter. Such a tendency may result from the following fact. That is, when the coat 52C was previously formed on the anode active material layer 52B before charge and discharge, the fixing characteristics, the physical durability and the like of the coat 52C were further improved and decomposition reaction of the electrolytic solution was more inhibited than in a case that the coat 52C was formed in charge and discharge. Accordingly, in the secondary battery of the invention, it was confirmed that the cycle characteristics were further improved when the coat was formed before charge and discharge.

### Comparative Example 5-1

A procedure was performed in the same manner as that of Example 1-7, except that the anode active material layer 52B was formed by using a carbon material as an anode active material. When the anode active material layer 52B was formed, 90 parts by weight of artificial graphite powder as an anode active material and 10 parts by weight of polyvinylidene fluoride as a binder were mixed to obtain an anode mixture. After that, the anode mixture was dispersed in N-methyl-2-pyrrolidone to obtain paste anode mixture slurry. Subsequently, the anode current collector 52A was uniformly coated with the anode mixture slurry, which was dried. After that, the resultant was compression-molded by a rolling press machine.

### Comparative Example 5-2

A procedure was performed in the same manner as that of Comparative example 1, except that the anode active material layer 52B was formed by using a carbon material as in Comparative example 5-1.

When the cycle characteristics and the like of the secondary batteries of Comparative examples 5-1 and 5-2 were examined, the results shown in Table 5 were obtained. Table 5 also shows the results of Examples 1-7, 2-2, and 3-2 and Comparative examples 1 to 3. Increase in retention ratio shown in Table 5 mean an increase amount of the discharge capacity retention ratio associated with formation of the coat 52C.

TABLE 5

| | | | Detection amount | | Discharge | |
|---|---|---|---|---|---|---|
| | | | of positive | | capacity | |
| | Anode active | | secondary ion | | retention | |
| | material layer | | (counting) | | ratio | Increase in |
| | (forming method) | Coat | Li₃SO₄⁺ | Li₃SO₃⁺ | (%) | rRetention ratio |
| Example 1-7 | Silicon | Li₂SO₄ + | 399810 | 865498 | 83 | +56 |
| | (evaporation | Li₂SO₃ + | | | | |
| | method) | Li₂S₂O₃ | | | | |
| Example 2-2 | Silicon | | 291832 | 714266 | 43 | +11 |
| | (sintering | | | | | |
| | method) | | | | | |
| Example 3-2 | SnCoC-containing | | 98311 | 409831 | 56 | +8 |
| | method | | | | | |
| | (coating method) | | | | | |
| Comparative | Silicon | — | — | — | 27 | — |
| example 1 | (evaporation | | | | | |
| | method) | | | | | |
| Comparative | Silicon | | | | 32 | — |
| example 2 | (sintering | | | | | |
| | method) | | | | | |
| Comparative | SnCoC-containing | | | | 48 | — |
| example 3 | material | | | | | |
| | (coating method) | | | | | |
| Comparative | Artificial graphite | Li₂SO₄ + | 64773 | 291822 | 36 | −2 |
| example 5-1 | (coating method) | Li₂SO₃ + | | | | |
| | | Li₂S₂O₃ | | | | |
| Comparative | | — | — | — | 38 | — |
| example 5-2 | | | | | | |

As shown in Table 5, in the case where the carbon material was used as an anode active material, results similar to the results of Table 1 were not obtained. More specifically, in the case where silicon or the SnCoC-containing material was used as an anode active material, in Examples 1-7, 2-2, and 3-2 in which the coat 52C was formed, the discharge capacity retention ration was higher than that of Comparative examples 1 to 3 in which the coat 52C was not formed (increase in retention ratio: from +8 to +56). Meanwhile, in the case where the carbon material was used as an anode active material, in Comparative example 5-1 in which the coat 52C was formed, the discharge capacity retention ratio was lower than that of Comparative example 5-2 in which the coat 52C was not formed (increase in retention ratio: −2). The reason of these results may be as follows. When the carbon material was used as an anode active material, the electrolytic solution tended to be hardly decomposed essentially, and thus decomposition inhibition effect of the electrolytic solution by the coat 52C was not exercised. Meanwhile, when silicon or the SnCoC-containing material was used as an anode active material, the electrolytic solution tended to be easily decomposed essentially, and thus decomposition inhibition effect of the electrolytic solution by the coat 52C was sufficiently exercised.

In particular, when the respective increase in retention ratio were compared to each other among Examples 1-7, 2-2, and 3-2, the increase in retention ratio of Examples 1-7 and 2-2 in which silicon was used tended to be larger than that of Example 3-2 in which the SnCoC-containing material was used as an anode active material. Furthermore, the increase in retention ratio of Example 1-7 using evaporation method tended to be larger than that of Example 2-2 using sintering method as a method of forming the anode active material layer 52B.

Accordingly, in the secondary battery of the invention, it was confirmed that in the case of using silicon or the SnCoC-containing material as an anode active material, the cycle characteristics were extremely improved more than in the case of using the carbon material. In this case, it was confirmed that the cycle characteristics in the case of using silicon were improved more than in the case of using the SnCoC-containing material, and the cycle characteristics in the case of using evaporation method were improved more than in the case of using sintering method.

As evidenced by the results of the foregoing Table 1 to Table 5, it was confirmed that the cycle characteristics were improved not depending on the type of the anode active material layer and the forming method thereof when the coat containing the metal salt having sulfur and oxygen was formed on the anode active material layer before charge and discharge or in charge and discharge in the case that the anode active material layer of the anode contained the anode material that is capable of inserting and extracting the electrode reactant and had at least one of the metal element and the metalloid element. In particular, it was confirmed that in this case, the cycle characteristics were extremely improved more than in the case of using the carbon material.

In Tables 1 to 5, the examples have been disclosed taking the coin type battery for example as a battery structure, and no examples of other battery structure such as a cylindrical type battery and a laminated type battery have been disclosed. However, since the foregoing effect is exercised not depending on the battery structure, it is evident that similar effects are obtained in a battery having other battery structure. Further, when an anode material that is capable of inserting and extracting the electrode reactant and has at least one of a metal element and a metalloid element is used, the electrolytic solution tended to be easily decomposed essentially. Thus, it is evident that similar effects are also obtained when the same kind of anode material as silicon and the SnCoC-containing material is used.

The invention has been described with reference to the several embodiments and the several examples. However, the invention is not limited to the aspects described in the foregoing respective embodiments and the foregoing examples, and various modifications may be made. For example, the anode of the invention is not necessarily used for the battery, but may be used for an electrochemical device other than the battery. As other application, for example, a capacitor or the like is cited.

Further, in the foregoing respective embodiments and the foregoing examples, the descriptions have been given of the case using the electrolytic solution or the gel electrolyte in which the electrolytic solution is held by the polymer compound as an electrolyte of the battery of the invention. However, other type of electrolyte may be used. As other electrolyte, for example, a mixture obtained by mixing an ion conductive inorganic compound such as ion conductive ceramics, ion conductive glass, and ionic crystal and an electrolytic solution; a mixture obtained by mixing other inorganic compound and an electrolytic solution; a mixture of the foregoing inorganic compound and a gel electrolyte or the like is cited.

Further, in the foregoing respective embodiments and the foregoing examples, the descriptions have been given of the lithium ion secondary battery in which the anode capacity is expressed based on insertion and extraction of lithium as a battery of the invention. However, the battery of the invention is not limited thereto. The invention is similarly applicable to a secondary battery in which the anode capacity includes the capacity based on insertion and extraction of lithium and the capacity based on precipitation and dissolution of lithium, and the anode capacity is expressed as the sum of these capacities, by setting the charge capacity of the anode active material capable of inserting and extracting lithium to a smaller value than the charge capacity of the cathode active material.

Further, in the foregoing respective embodiments and the foregoing examples, the description has been given of the case using lithium as an electrode reactant. However, as an electrode reactant, other Group 1A element in the short periodic table such as sodium (Na) and potassium (K), a Group 2A element such as magnesium and calcium (Ca), or other light metal such as aluminum may be used. In these cases, the anode material described in the foregoing respective embodiments may be used as an anode active material as well.

Further, in the foregoing respective embodiments and the foregoing examples, for the battery of the invention, the descriptions have been given with the specific examples of the batteries having a battery structure of cylindrical type, laminated film type, and coin type, and with the specific example of the battery in which the battery element has the spirally wound structure. However, the invention is similarly applicable to a battery having other structure such as a square type battery and a button type battery, or a battery in which the battery element has other structure such as a lamination structure. The battery of the invention is similarly applicable to other type of battery such as a primary battery in addition to the secondary battery.

Further, in the foregoing respective embodiments and the foregoing examples, for the detection amount of Li₃SO₄+ or Li₃SO₃+ in the anode or the battery of the invention, the numerical value range thereof derived from the results of the examples has been described as the appropriate range. However, such a description does not totally eliminate the possibility that the detection amount may be out of the foregoing range. That is, the foregoing appropriate range is the range particularly preferable for obtaining the effects of the invention. Therefore, as long as effects of the invention may be obtained, the detection amount may be out of the foregoing range in some degrees.

It should be understood by those skilled in the art that various modifications, combinations, sub-combinations and alternations may occur depending on design requirements and other factors insofar as they are within the scope of the appended claims or the equivalents thereof.

What is claimed is:

1. An anode comprising:
a coat on an anode active material layer provided on an anode current collector,
wherein the anode active material layer contains an anode material that is capable of inserting and extracting an electrode reactant and has at least one of a metal element and a metalloid element, and
the coat contains a metal salt having sulfur (S) and oxygen (O).

2. The anode according to claim 1, wherein the metal salt is at least one selected from the group consisting of sulfate, subsulfate, and thiosulfate.

3. The anode according to claim 1, wherein the metal salt is a salt of the same type of metal as the electrode reactant.

4. The anode according to claim 1, wherein at least one peak of ions selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion is obtained by surface analysis using Time of Flight Secondary Ion Mass Spectrometry.

5. The anode according to claim 4, wherein when Bi₃+ (9.7952×10¹¹ ions/cm²) as a primary ion is applied, counting of a detection amount of Li₃SO₄+ is 10000 or more.

6. The anode according to claim 4, wherein when Bi₃+ (9.7952×10¹¹ ions/cm²) as a primary ion is applied, counting of a detection amount of Li₃SO₃+ is 9000 or more.

7. The anode according to claim 1, wherein the anode material is at least one selected from the group consisting of a simple substance of silicon (Si), an alloy of silicon, a compound of silicon, a simple substance of tin (Sn), an alloy of tin, and a compound of tin.

8. The anode according to claim 1, wherein the anode material is a material having
tin as a first element,
at least one selected from the group consisting of cobalt (Co), iron (Fe), magnesium (Mg), titanium (Ti), vanadium (V), chromium (Cr), manganese (Mn), nickel (Ni), copper (Co), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon as a second element, and
at least one selected from the group consisting of boron (B), carbon (C), aluminum (Al), and phosphorus (P) as a third element.

9. A method of manufacturing an anode, wherein after an anode active material layer containing an anode material that is capable of inserting and extracting an electrode reactant and has at least one of a metal element and a metalloid element is formed on an anode current collector, a coat is formed on the anode active material layer by using a solution containing a metal salt having sulfur and oxygen.

10. A battery comprising:
a cathode;
an anode; and
an electrolytic solution,
wherein the anode has a coat on an anode active material layer provided on an anode current collector,
the anode active material layer contains an anode material that is capable of inserting and extracting an electrode reactant and has at least one of a metal element and a metalloid element, and
the coat contains a metal salt having sulfur and oxygen.

11. The battery according to claim 10, wherein the metal salt is at least one selected from the group consisting of sulfate, subsulfate, and thiosulfate.

12. The battery according to claim 10, wherein the metal salt is a salt of the same type of metal as the electrode reactant.

13. The battery according to claim 10, wherein at least one peak of ions selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion is obtained by surface analysis of the anode using Time of Flight Secondary Ion Mass Spectrometry.

14. The battery according to claim 13, wherein when Bi₃+ (9.7952×10¹¹ ions/cm²) as a primary ion is applied, counting of a detection amount of Li₃SO₄+ is 10000 or more.

15. The battery according to claim 13, wherein when Bi₃+ (9.7952×10¹¹ ions/cm²) as a primary ion is applied, counting of a detection amount of Li₃SO₃+ is 9000 or more.

16. The battery according to claim 10, wherein the anode material is at least one selected from the group consisting of a simple substance of silicon, an alloy of silicon, a compound of silicon, a simple substance of tin, an alloy of tin, and a compound of tin.

17. The battery according to claim 10, wherein the anode material is a material having
tin as a first element,
at least one selected from the group consisting of cobalt, iron, magnesium, titanium, vanadium, chromium, manganese, nickel, copper, zinc, gallium, zirconium, niobium, molybdenum, silver, indium, cerium, hafnium, tantalum, tungsten, bismuth, and silicon as a second element, and
at least one selected from the group consisting of boron, carbon, aluminum, and phosphorus as a third element.

18. The battery according to claim 10, wherein the cathode has a cathode active material layer partially provided on a cathode current collector, and
the coat is provided in both a region opposed to the cathode active material layer and a region not opposed to the cathode active material layer.

19. A method of manufacturing a battery including a cathode, an anode, and an electrolytic solution in which the anode has a coat on an anode active material layer provided on an anode current collector,
wherein after the anode active material layer containing an anode material that is capable of inserting and extracting an electrode reactant and has at least one of a metal element and a metalloid element is formed on the anode current collector, the coat is formed on the anode active material layer by using a solution containing a metal salt having sulfur and oxygen.

20. A battery comprising:
a cathode;
an anode; and
an electrolytic solution,
wherein the anode has an anode active material layer provided on an anode current collector,
the anode active material layer contains an anode material that is capable of inserting and extracting an electrode reactant and has at least one of a metal element and a metalloid element,
the electrolytic solution contains a compound having a sulfonyl group (>SO₂), and
at least one peak of ions selected from the group consisting of Li₃SO₄+, Li₃SO₃+, Li₂SO₃+, and Li₂SO₂+ as a positive secondary ion and LiSO₄−, LiSO₃−, SO₃−, and SO₂− as a negative secondary ion is obtained by surface analysis of the anode using Time of Flight Secondary Ion Mass Spectrometry after charge and discharge.

21. The battery according to claim 20, wherein the compound having a sulfonyl group is an acid anhydride.

22. The battery according to claim 20, wherein the compound having a sulfonyl group is at least one selected from the group consisting of compounds shown in Chemical formula 1, Chemical formula 2, and Chemical formula 3.

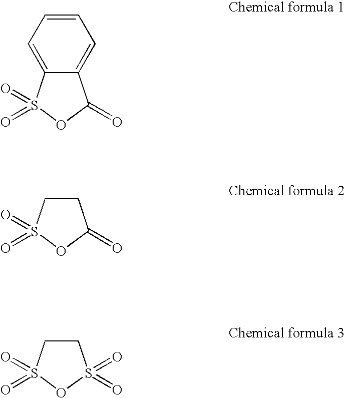

23. The battery according to claim 20, wherein when Bi₃+ (9.7952×10¹¹ ions/cm²) as a primary ion is applied, counting of a detection amount of Li₃SO₄+ is 10000 is more.

24. The battery according to claim 20, wherein when Bi₃+ (9.7952×10¹¹ ions/cm²) as a primary ion is applied, counting of a detection amount of Li₃SO₃+ is 9000 or more.

25. The battery according to claim 20, wherein the anode material is at least one selected from the group consisting of a simple substance of silicon, an alloy of silicon, a compound of silicon, a simple substance of tin, an alloy of tin, and a compound of tin.

26. The battery according to claim 20, wherein the anode material is a material having
tin as a first element,
at least one selected from the group consisting of cobalt, iron, magnesium, titanium, vanadium, chromium, manganese, nickel, copper, zinc, gallium, zirconium, niobium, molybdenum, silver, indium, cerium, hafnium, tantalum, tungsten, bismuth, and silicon as a second element, and
at least one selected from the group consisting of boron, carbon, aluminum, and phosphorus as a third element.

27. The battery according to claim 20, wherein the anode has a coat on the anode active material layer after charge and discharge, and
the coat contains a metal salt having sulfur and oxygen.

28. The battery according to claim 20, wherein the cathode has a cathode active material layer partially provided on a cathode current collector, and
the coat is provided in a region opposed to the cathode active material layer.
